(19) United States
(12) Patent Application Publication
(10) Pub. No.: US 2012/0262556 A1
(43) Pub. Date: Oct. 18, 2012

(54) DETECTING CROSSTALK ON A DISPLAY SURFACE COMPARTMENTALIZED INTO DISPLAY REGIONS BY IMAGE PATTERNS CONTAINED IN AN INPUT IMAGE SIGNAL TO A DISPLAY DEVICE

(76) Inventors: Yasuhiro KUWAHARA, Osaka (JP); Masahiro Kawashima, Tokyo (JP); Hiroshi Miyai, Hyogo (JP)

(21) Appl. No.: 13/531,929

(22) Filed: Jun. 25, 2012

Related U.S. Application Data
(63) Continuation of application No. PCT/JP2011/006023, filed on Oct. 27, 2011.
(60) Provisional application No. 61/408,330, filed on Oct. 29, 2010.

(51) Int. Cl. H04N 13/04

(52) U.S. Cl. 348/51; 348/E13.075

(57) ABSTRACT

The instant application describes a method for detecting crosstalk on a display surface compartmentalized into display regions by image patterns that are contained in an input image signal to a display device. The method includes steps of: displaying a first image and a second image on a display surface, the first image including first pattern images having main regions depicted with different brightness from each other and the second image including second pattern images having the main regions and sub regions depicted with different brightness from the main regions; taking an image of the display surface to obtain image data; and comparing at least one of the first and second images with the image data to detect the crosstalk. The first and second pattern images are displayed in a center region at a center of the display surface and adjacent regions adjacent to the center region.

### TECHNICAL FIELD

The present application relates to technologies for detecting crosstalk on a display surface compartmentalized into display regions by image patterns contained in an input image signal to a display device.

### BACKGROUND OF THE INVENTION

“Crosstalk” often arises as a problem in a technical field of display devices for displaying images. The term “crosstalk” often means deterioration in image quality caused by interference between a few images.

Patent Document 1 discloses a method for measuring the crosstalk, which is generated between two image regions that are horizontally aligned. The technology disclosed in Patent Document 1 contributes to quantification of the crosstalk generated in one frame image.

The term “crosstalk” not only refers to the deterioration in image quality arising between display regions which are different in position but also refers to deterioration in image quality arising in one display region. In particular, the “crosstalk” arising in a specific display region interferes with displaying a stereoscopic image.

In order to display a stereoscopic image, typically, a display device alternately displays a left frame image, which is viewed by the left eye, and a right frame image, which is viewed by the right eye. For example, the left and right frame images are created so that a display position of an object depicted in the left frame image differs from a display position of an object rendered in the right frame image by parallax.

A viewer typically wears an eyewear device to view the stereoscopic image. For example, the eyewear device includes a left shutter, which is disposed in front of the left eye, and a right shutter, which is disposed in front of the right eye. While the left frame image is displayed, the left shutter is opened whereas the right shutter is closed. While the right frame image is displayed, the right shutter is opened whereas the left shutter is closed. Accordingly, the viewer may view the left frame image only with the left eye and the right frame image only with the right eye. Consequently, the viewer may stereoscopically perceive the video displayed by the display device in response to the parallax between the left and right frame images.

For example, if the display device displays a video by means of a liquid crystal panel, a part of a right frame image, which is previously displayed, may be displayed on a specific region of the liquid crystal panel while the left shutter is open because of delay in response of the liquid crystals. A part of a left frame image, which is previously displayed, may be displayed on a specific region of the liquid crystal panel while the right shutter is open. Therefore, a viewer may observe a video in which the left and right frame images are mixed.

For example, if the display device displays a video by means of a PDP (plasma display panel), the right frame image, which is previously displayed, may interfere with a specific region of the left frame image while the left shutter is open because of light emission characteristics of the light emitters. The left frame image, which is previously displayed, may interfere with a specific region of the right frame image while the right shutter is open. Therefore, a viewer may observe a video, which is affected by the previously displayed frame image.

Deterioration in the image quality caused by the interference between the left and right frame images is also referred to as “crosstalk”. This “crosstalk” is generally referred to as “interocular crosstalk”, but is hereinafter simply referred to as “crosstalk” in this specification. Patent Document 2 discloses techniques to evaluate the crosstalk caused by the interference between frame images.

Other techniques to evaluate the crosstalk caused by interference between frame images are disclosed in the following video site (http://video.consumerreports.org/services/player/bcpid1886192484?bctid=624905278001). According to the foregoing disclosed technologies, a first image depicted with several rectangular regions, which horizontally extend, and a second image including several rectangular regions, which horizontally extend, and several triangular regions depicted in the rectangular regions are alternately displayed.

The rectangular regions of the first and second images are vertically aligned. The first and second images decrease brightness of the vertically aligned rectangular regions downward to form a gradation pattern in which the brightness changes in the vertical direction. It should be noted that the rectangular regions have a uniform brightness in the horizontal direction.

The triangular regions are arranged in a matrix. The second image is obtained by superimposing the first image (depicted by the horizontally extended rectangular regions) and the triangular regions arranged in a matrix. Brightness of the triangular regions, which are aligned in the horizontal direction, gradually increases whereas brightness of the triangular regions, which are aligned in the vertical direction, is uniform.

The display device alternately displays the first and second images. The shutter of the eyewear device opens an optical path of the video light in synch with the display of the first image. As a result of the aforementioned crosstalk, the viewer may observe the triangular regions during the display period of the first image which consists of the rectangular regions.

The response characteristics of the liquid crystals and the light emission characteristics of light emitters are susceptible to a temperature. As described above, the crosstalk depends on the response characteristics of liquid crystals and the light emission characteristics of light emitters. Since it takes a long time to evaluate the crosstalk measurement for the entire display surface displaying the video on the basis of the known crosstalk evaluation techniques described above, the obtained data about the crosstalk becomes severely affected by the temperature. Accordingly, it is difficult to acquire reproducible data on the basis of the known evaluation techniques.

Upon evaluating the crosstalk, viewing angle characteristics should not be ignored. For example, if the display device uses a liquid crystal panel to display a video, brightness or hue of the video observed by the viewer may change in response to a viewing direction of a viewer watching the video. The foregoing known evaluation techniques fail to give consideration to the viewing angle characteristics. Accordingly, the crosstalk data obtained from the known evaluation techniques may deviate from actual perception of the viewer about the video. Consequently, the crosstalk data on the basis of the known evaluation techniques may become less reliable.
Patent Document 1: JP 2009-239596 A
Patent Document 2: JP 2011-64894 A

### SUMMARY

In one general aspect, the instant application describes a method for detecting crosstalk on a display surface compartmentalized into display regions by image patterns that are contained in an input image signal to a display device. The method includes steps of: displaying a first image and a second image on a display surface, the first image including first pattern images having main regions depicted with different brightness from each other and the second image including second pattern images having the main regions and sub regions depicted with different brightness from the main regions; taking an image of the display surface to obtain image data; and comparing at least one of the first and second images with the image data to detect the crosstalk. The first and second pattern images are displayed in a center region at a center of the display surface and adjacent regions adjacent to the center region.

The above general aspect may include one or more of the following features. The method may further include steps of: compartmentalizing the display surface into the center region and the adjacent regions surrounding the center region, displaying the first pattern images in the center region and each of the adjacent regions, and displaying the second pattern images in the center region and each of the adjacent regions. The display surface may be compartmentalized into nine display regions.

The main regions may include a first main region depicted with first brightness, a second main region depicted with second brightness, which is higher than the first brightness, and a third main region depicted with third brightness, which is higher than the second brightness. The main regions may include a first main region depicted with first brightness. The sub regions may include a first region group including sub regions, which are depicted with different brightness from each other, within the first main region. The sub regions may be rectangular or circular.

The main regions may include a first main region depicted with first brightness. The first main region may be a horizontal strip region extending in a horizontal direction or a vertical strip region extending in a vertical direction. The sub regions may be formed in the first main region. The sub regions may form a gradation pattern in which the brightness increases or decreases in the horizontal direction in the horizontal strip region, or form a gradation pattern in which the brightness increases or decreases in the vertical direction in the vertical strip region.

The first main region may be a strip region extending in a first direction. The sub regions may include second region groups, which include sub regions aligned in a second direction orthogonal to the first direction. The second region groups may be aligned at regular intervals in the first direction. The average brightness of each of the first pattern images may be equal to an average brightness of each of the second pattern images. In the step of displaying the first and second images on the display surface, an average brightness of the display surface may be maintained within a range of 15% or more and 25% or less.

In another general aspect, the instant application describes a signal generating device configured to generate image signals for displaying images used for detecting crosstalk on a display surface of a display device. The signal generating device includes a signal generation portion configured to generate a first signal for displaying a first image and a second signal for displaying a second image, the first image includes first pattern images having main regions depicted with different brightness from each other and the second image includes second pattern images having the main regions and sub regions depicted with different brightness from the main regions. The signal generating device also includes an output portion configured to output the first and second signals. The signal generation portion is configured to generate the second signal so that the second pattern images are displayed in a center region at a center of the display surface and adjacent regions adjacent to the center region and to generate the first signal so that the first pattern images are displayed in the center region and each of the adjacent regions.

In another general aspect, the instant application describes a computer-readable non-transitory medium storing an image file to be used for detecting crosstalk on a display surface compartmentalized into display regions by image patterns that are contained in an input image signal to a display device. The computer-readable non-transitory medium is configured to store data about a first image and a second image. The first image includes first pattern images having main regions depicted with different brightness from each other. The second image includes second pattern images having the main regions and sub regions depicted with different brightness from the main regions. The computer-readable non-transitory medium is further configured to display the first and second pattern images on the display regions.

In another general aspect, the instant application describes a display device that includes a display surface configured to display a first image including first pattern images that have main regions depicted with different brightness from each other. The display surface is being compartmentalized into display regions, each display region being used to display one of the first pattern images. The display device further includes an input portion configured to receive a first signal for displaying the first image and a second signal for displaying a second image including second pattern images that have the main regions and sub regions depicted with different brightness from the main regions on the display surface; and an adjuster configured to adjust brightness characteristics of the display surface. The display surface is configured to display each of the second pattern images in one of the display regions if the second signal is input to the input portion.

In another general aspect, the instant application describes a method for manufacturing a display device including a display surface which is compartmentalized into display regions by image patterns contained in an image signal. The method includes steps of: displaying a first image and a second image on a display surface, the first image including first pattern images having main regions depicted with different brightness from each other and the second image including second pattern images having the main regions and sub regions depicted with different brightness from the main regions; taking an image of the display surface to obtain image data; and comparing at least one of the first and second images with the image data to inspect crosstalk characteristics.

The various techniques for detecting the crosstalk described above enable acquisition of reproducible data about the crosstalk. The data may be acquired under similar conditions to an actual viewing environment of a viewer.

The object, features and advantages of the present invention will become more apparent based on the ensuing detailed description and appended drawings.

### BRIEF DESCRIPTION OF THE DRAWINGS

The figures depict one or more implementations in accord with the present teachings, by way of example only, not by way of limitations. In the figures, like reference numerals refer to the same or similar elements.

FIG. 1 is a schematic view of a measurement system configured to detect and measure the crosstalk.

FIG. 2 is a schematic front view of a display surface of a display device of the measurement system shown in FIG. 1.

FIG. 3 schematically shows a first crosstalk detection image, which is displayed on the display surface depicted in FIG. 2.

FIG. 4 schematically shows a second crosstalk detection image, which is displayed on the display surface depicted in FIG. 2.

FIG. 5 is a schematic block diagram of a signal generating device of the measurement system shown in FIG. 1.

FIG. 6 is a schematic block diagram of the display device of the measurement system shown in FIG. 1.

FIG. 7 is a schematic view of a first pattern image included in the detection image shown in FIG. 3.

FIG. 8 is a schematic view of a second pattern image included in the detection image shown in FIG. 4.

FIG. 9 schematically shows frame images used for displaying a stereoscopic image.

FIG. 10A is a schematic view of regional segments of the display surface which switches the image display from a left frame image to a right frame image.

FIG. 10B is a schematic view of regional segments of the display surface which switches the image display from a right frame image to a left frame image.

FIG. 11A is a schematic timing chart showing falling crosstalk which is perceived by the right eye.

FIG. 11B is a timing chart in which the graphs shown in FIG. 11A are superimposed.

FIG. 12A is a schematic timing chart showing rising crosstalk which is perceived by the left eye.

FIG. 12B is a timing chart in which the graphs shown in FIG. 12A are superimposed.

FIG. 13 is a schematic view showing a change in brightness upon alternately displaying the first and second pattern images depicted in FIGS. 7 and 8.

FIG. 14 is a schematic view showing measurement positions of brightness values for calculating an average value of the crosstalk.

FIG. 15 is a schematic flowchart of a method for detecting the crosstalk which appears on the display surface shown in FIG. 2.

FIG. 16 is a schematic flowchart of a setup process of the detection method shown in FIG. 15.

FIG. 17 is a schematic view showing an exemplary screen for setting measurement conditions in the setup process shown in FIG. 16.

FIG. 18 is a schematic flowchart of a display process and an image capturing process of the detection method shown in FIG. 15.

FIG. 19A is a schematic view of an exemplary combination of images, which are used in the display process shown in FIG. 18.

FIG. 19B is a schematic view of another exemplary combination of images, which are used in the display process shown in FIG. 18.

FIG. 20 is a schematic view showing resultant crosstalk, which is obtained by the flowchart shown in FIG. 15.

FIG. 21 is a schematic flowchart of an exemplary manufacturing process of the display device shown in FIG. 6.

FIG. 22A is a schematic view of another exemplary combination of the pattern images, which are used for evaluating the crosstalk.

FIG. 22B is a schematic view of yet another exemplary combination of the pattern images, which are used for evaluating the crosstalk.

FIG. 23A is a schematic view of another exemplary first image, which is used for detecting the crosstalk.

FIG. 23B is a schematic view of another exemplary second image, which is used for detecting the crosstalk.

FIG. 24 is a schematic view of the second image shown in FIG. 23B and represents dimensions of the second image therein.

FIG. 25 is a schematic view of another exemplary second image, which is used for detecting the crosstalk.

FIG. 26 is a schematic view of yet another exemplary second pattern image, which is used for detecting the crosstalk.

FIG. 27A is a schematic view of another exemplary first pattern image, which is used for detecting the crosstalk.

FIG. 27B is a schematic view of yet another exemplary second pattern image, which is used for detecting the crosstalk.

FIG. 28 is a flowchart schematically showing an exemplary process, which is executed by a signal generation program for causing the signal generating device shown in FIG. 5 to generate first and second signals.

FIG. 29 is a schematic view of crosstalk measurement under a display environment in which a single pattern image is displayed.

### DETAILED DESCRIPTION

In the following detailed description, numerous specific details are set forth by way of examples in order to provide a thorough understanding of the relevant teachings. However, it should be apparent to those skilled in the art that the present teachings may be practiced without exemplary details. In other instances, well known methods, procedures, components, and/or circuitry have been described at a relatively high-level, without detail, in order to avoid unnecessarily obscuring aspects of the present concepts.

In exchange for the present disclosure herein, the Applicants desire all patent rights described in the claims. Therefore, the patent rights are not intended to be limited or restricted by the following detailed description and accompanying figures.

A method for detecting the crosstalk, a computer-readable medium storing an image file, which is used for generating signals for detecting the crosstalk, a display device which displays images by means of the signals for detecting the crosstalk, and a manufacturing method of a display device are described with reference to the drawings. It should be noted that the same reference numerals are given to the same constituent elements in various implementations described below. In order to clarify the description, redundant explanations are omitted as appropriate. Configurations, arrangements or shapes shown in the drawings and the descriptions related to the drawings are provided to make principles of the various implementations easily understood. Accordingly, the principles of the various implementations are not in any way limited by the drawings and the detailed description with reference to the drawings.

### (Measurement System)

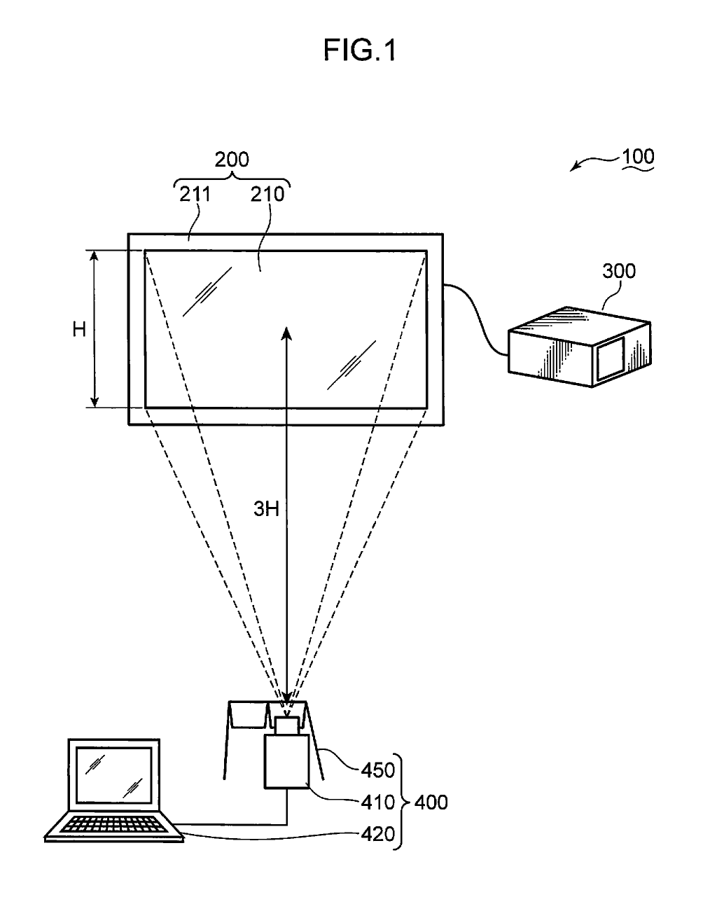

FIG. 1 is a schematic view of the measurement system 100 configured to detect and measure the crosstalk. The measurement system 100 includes a display device 200, a signal generating device 300, and an image capturing device 400. The display device 200 is configured to display a crosstalk detection image used for detecting crosstalk. The display device 200 includes a display surface 210 for displaying the crosstalk detection image and a housing 211 for storing the display surface 210. For example, the display device 200 may be a TV device, a display device of a personal computer, or another device capable of displaying images. In particular, the principle of this implementation may be suitably applied to a display device which displays stereoscopic images.

The signal generating device 300 is configured to generate a detection image signal for displaying the crosstalk detection image on the display surface 210 of the display device 200. The signal generating device 300 is electrically connected to the display device 200. The display device 200 displays the crosstalk detection image on the display surface 210 in response to the detection image signal transmitted from the signal generating device 300. Consequently, crosstalk appears on the display surface 210. The method for evaluating the crosstalk by means of the crosstalk detection image is described later.

The image capturing system 400 is configured to take an image of the crosstalk detection image displayed on the display surface 210. The image capturing system 400 includes a shutter device 450, a camera device 410, and a processing device 420 (e.g., a personal computer). The shutter device 450 is configured to open and close in synch with switching operation of frame images displayed on the display device 200. The camera device 410 is configured to take an image of the overall display surface 210. The processing device 420 is configured to execute evaluation processes of crosstalk by means of the image (i.e., image data) of the display surface 210, which is taken by the camera device 410.

In this implementation, an eyewear device used for viewing stereoscopic images is used as the shutter device 450. Crosstalk on the display surface 210 is detected by comparing the image data about the display surface 210 captured by the camera device 410 with the crosstalk detection image, which is generated in response to the detection image signal output by the signal generating device 300. Accordingly, if a video of the display surface 210, which may be compared with the crosstalk detection image, is acquired, another image capturing system may be used. The crosstalk evaluation processes performed by the processing device 420 are described later.

In FIG. 1, a height dimension of the display surface 210 is represented by the symbol “H”. In general, it is recommended that there is a distance approximately three times as long as the height dimension of the display surface from a viewer, who views a stereoscopic image displayed on the display surface to the display surface. Accordingly, the image capturing system 400 is preferably disposed approximately 3×H away from the display surface 210. This allows for acquiring the crosstalk data under an environment similar to an actual viewing environment.

### (Display Region)

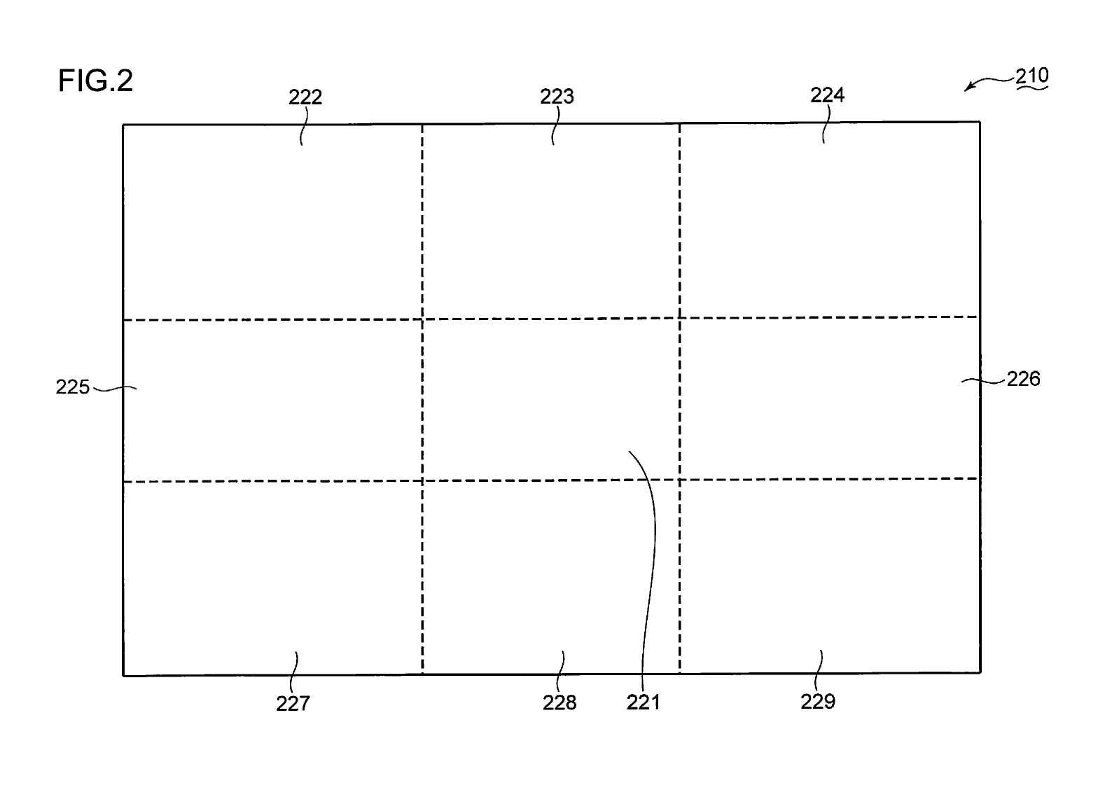

FIG. 2 is a schematic front view of the display surface 210. In one implementation, the display surface 210 is compartmentalized into several display regions by several identical image patterns contained in an input image signal to the display device 200. In this implementation, the display surface 210 is conceptually compartmentalized into nine display regions 221 to 229. The display region 221 positioned at the center of the display surface 210 is exemplified as the center region.

The region at the upper left of the display region 221 is the display region 222. The region immediately above the display region 221 is the display region 223. The region at the upper right of the display region 221 is the display region 224. The region on the left of the display region 221 is the display region 225. The region on the right of the display region 221 is the display region 226. The region at the lower left of the display region 221 is the display region 227. The region immediately below the display region 221 is the display region 228. The region at the lower right of the display region 221 is the display region 229. In this implementation, the display regions 222 to 229 arranged so as to surround the display region 221 are exemplified as the adjacent regions.

In this implementation, the display surface 210 is conceptually compartmentalized into the nine display regions 221 to 229. In another implementation, a number of display regions on the display surface may be less than nine (e.g., between two to eight). In yet another implementation, a number of display regions on the display surface may be more than nine (e.g., more than ten). In this implementation, the nine display regions 221 to 229 are identical in shape and size to each other. In another implementation, the display regions compartmentalized in the display surface may be different in size or shape from each other.

### (Detection Image)

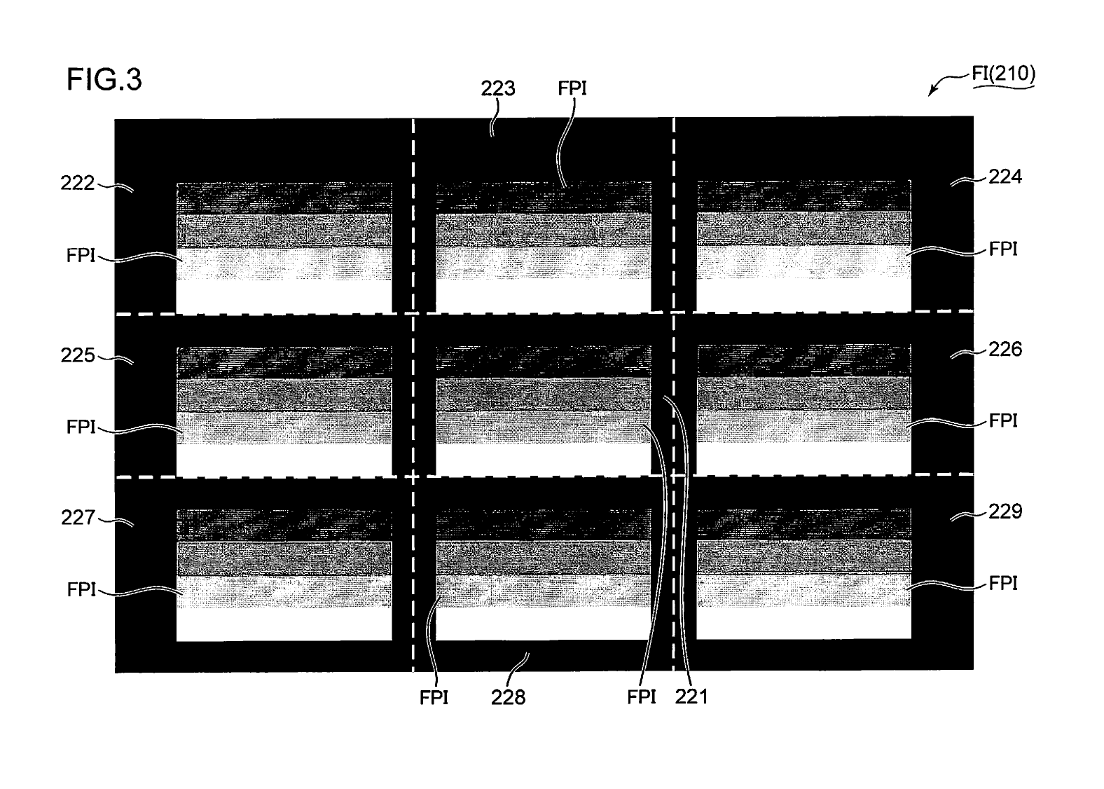

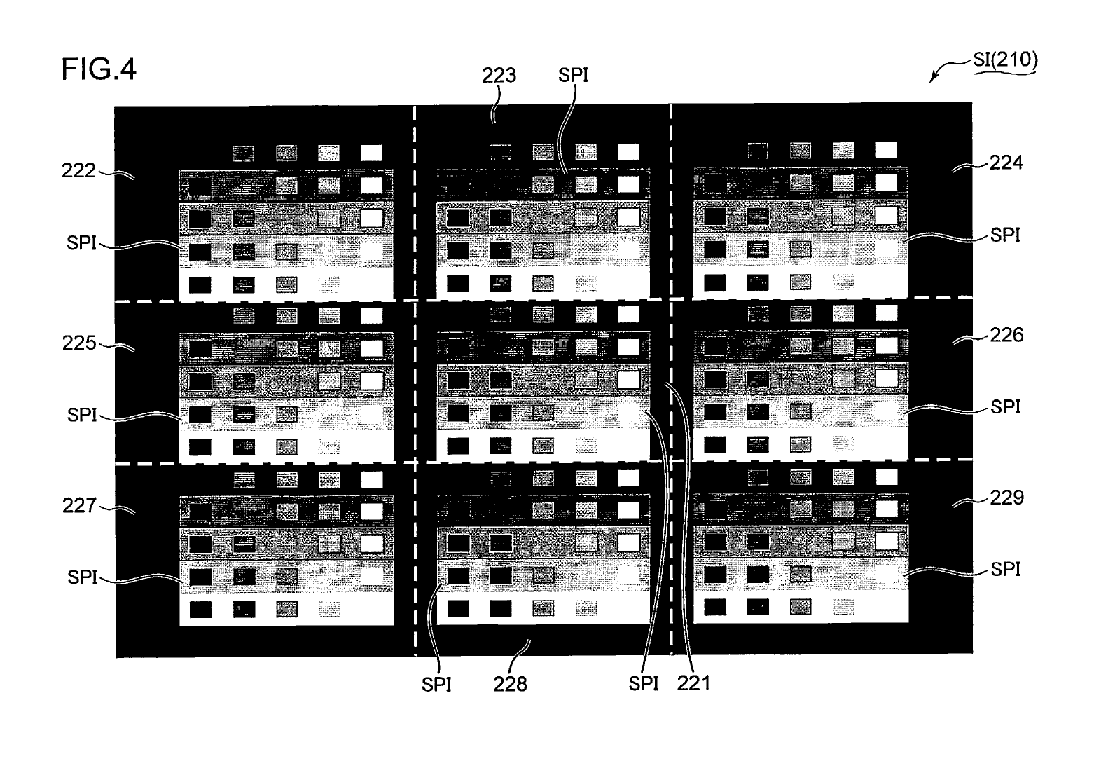

FIGS. 3 and 4 schematically show the crosstalk detection images, which are displayed on the display surface 210. In this implementation, the first image FI shown in FIG. 3 and the second image SI shown in FIG. 4 are used as the crosstalk detection images. The first and second images FI, SI are alternately displayed on the display surface 210. Consequently, crosstalk appears on the display surface 210. The first image FI includes nine first pattern images FPI. The first pattern image FPI is displayed in each of the display regions 221 to 229. It should be noted that a number of first pattern images contained in the first image is not limited to nine so long as the number of the first pattern images can coincide with the number of display regions into which the display surface is compartmentalized. The first pattern image FPI displayed on each of the display regions 221 to 229 is identical to each other. Alternatively, different first pattern images in brightness, shape or size may be displayed on the display regions 221 to 229.

The second image SI includes nine second pattern images SPI. The second pattern image SPI is displayed in each of the display regions 221 to 229. The position of the second pattern image SPI on the display surface 210 substantially coincides with the display position of the corresponding first pattern image FPI. It should be noted that a number of second pattern images contained in the second image is not limited to nine so long as the number of the second pattern images can coincide with the number of the first pattern images. The second pattern image SPI displayed on each of the display regions 221 to 229 is identical to each other. Alternatively, different second pattern images in brightness, shape or size may be displayed on the display regions 221 to 229.

### (Configuration of Signal Generating Device)

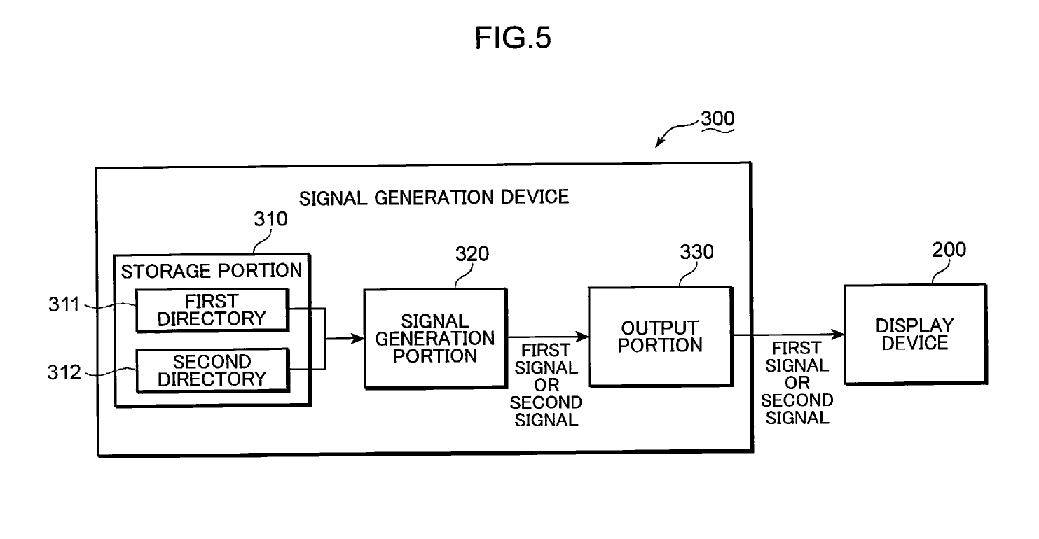

FIG. 5 is a schematic block diagram of the signal generating device 300. The signal generating device 300 includes a storage portion 310, a signal generation portion 320, and an output portion 330. The storage portion 310 is configured to store a data file of the detection image. The storage portion 310 includes a first directory 311 for storing data about the first image FI and a second directory 312 for storing data about the second image SI. In this implementation, the data file of the detection image is exemplified as the image file. The storage portion 310 is exemplified as a computer-readable medium storing an image file for generating signals used for crosstalk detection. The storage portion 310 may be a ROM, a hard disk or alike. Alternatively, the storage portion 310 may be a removable medium which may be removed from the signal generating device 300 as appropriate.

The signal generation portion 320 is configured to generate signals for displaying the first and second images FI, SI by means of the data file stored in the storage portion 310. The signal generation portion 320 reads data about the first image FI from the first directory 311 to generate a first signal for displaying the first image FI on the display surface 210. The signal generation portion 320 also reads data about the second image SI from the second directory 312 to generate a second signal for displaying the second image SI on the display surface 210. The output portion 330 is configured to receive the first and second signals, which are generated and output by the signal generation portion 320. The output portion 330 alternately outputs the first and second signals to the display device 200.

### (Configuration of Display Device)

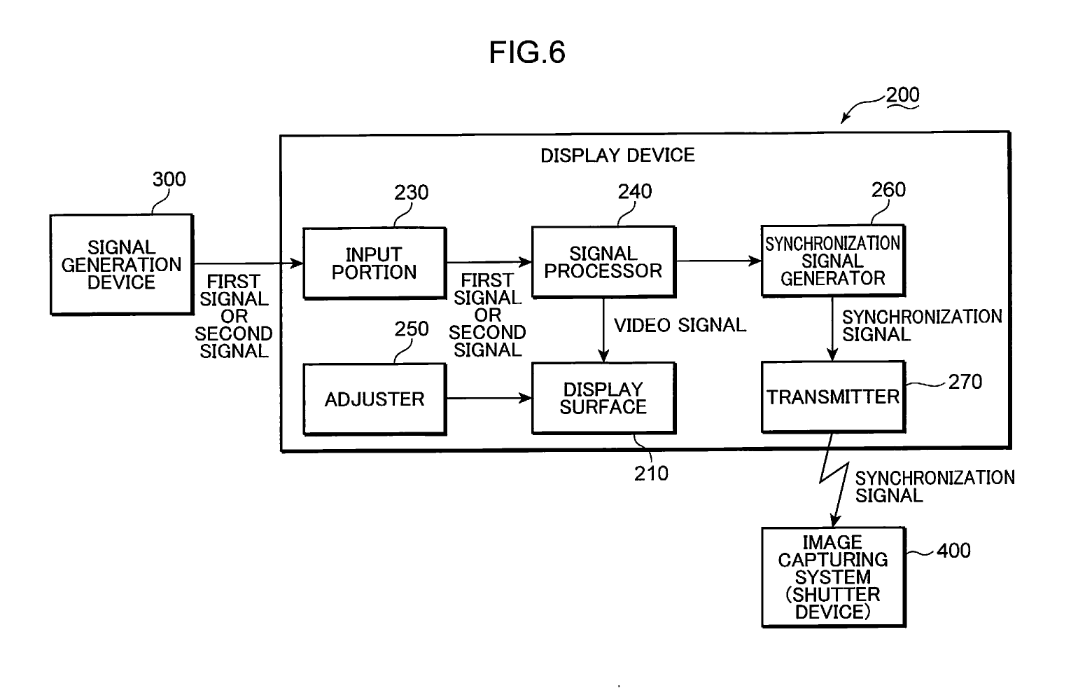

FIG. 6 is a schematic block diagram of the display device 200. The display device 200 includes the display surface 210, an input portion 230, a signal processor 240, an adjuster 250, a synchronization signal generator 260, and a transmitter 270. The input portion 230 is configured to receive the first and second signals which are output from the signal generating device 300. In this implementation, the first and second signals are alternately input to the input portion 230. The input portion 230 thereafter outputs the first and second signals.

The signal processor 240 is configured to process the first and second signals, which are output from the input portion 230, to generate a video signal for displaying an image on the display surface 210. The signal processor 240 generates a video signal for displaying the first image FI in response to the first signal and generates a video signal for displaying the second image SI in response to the second signal.

The adjuster 250 is configured to adjust brightness characteristics of the display surface 210. As described with reference to FIGS. 3 and 4, the display surface 210 is conceptually compartmentalized into the display regions 221 to 229. The first and second pattern images FPI, SPI are alternately displayed on each of the display regions 221 to 229. Therefore, crosstalk characteristics are identified in each of the display regions 221 to 229. The adjuster 250 may selectively adjust the brightness characteristics for each of the display regions 221 to 229. For example, if distinct crosstalk is observed in the display region 229, a user may use the adjuster 250 to adjust the brightness characteristics of the display region 229 so that a light emitting timing of the display region 229 precedes the other display regions. Alternatively, the user may use the adjuster 250 to increase or decrease brightness of the display region 229 to reduce the crosstalk. Alternatively, the adjuster 250 may adjust parameters of the crosstalk cancellation processes (not shown) to increase or decrease one of the left and right voltage levels (signal level) in a specific region in response to generated crosstalk.

The synchronization signal generator 260 is configured to generate a synchronization signal, which makes display of the images (the first and second images) on the display surface 210 synchronized with operation of the image capturing system 400. The synchronization signal is used for notifying display timings of the first and second images to the image capturing system.

The transmitter 270 is configured to transmit the synchronization signal to the image capturing system 400. In this implementation, the transmitter 270 transmits a radio signal as the synchronization signal to the image capturing system 400. Alternatively, the transmitter may output the synchronization signal to the image capturing system 400 via a wire.

As described with reference to FIG. 1, in this implementation, the image capturing system 400 uses the eyewear device, which is generally used as the shutter device 450 for viewing stereoscopic images. Accordingly, the synchronization control between the image capturing system 400 and the display device 200 may be achieved on the basis of various known control methods. It should be noted that the principle of this implementation may similarly be applied to a passive display system, although this implementation is described with the active display system. If the passive eyewear device is used, the synchronization signal generator and the transmitter may be omitted. In the passive display system, the first and second images are synthesized and displayed. For example, the first and second images may be displayed by being switched every line.

### (Pattern Image)

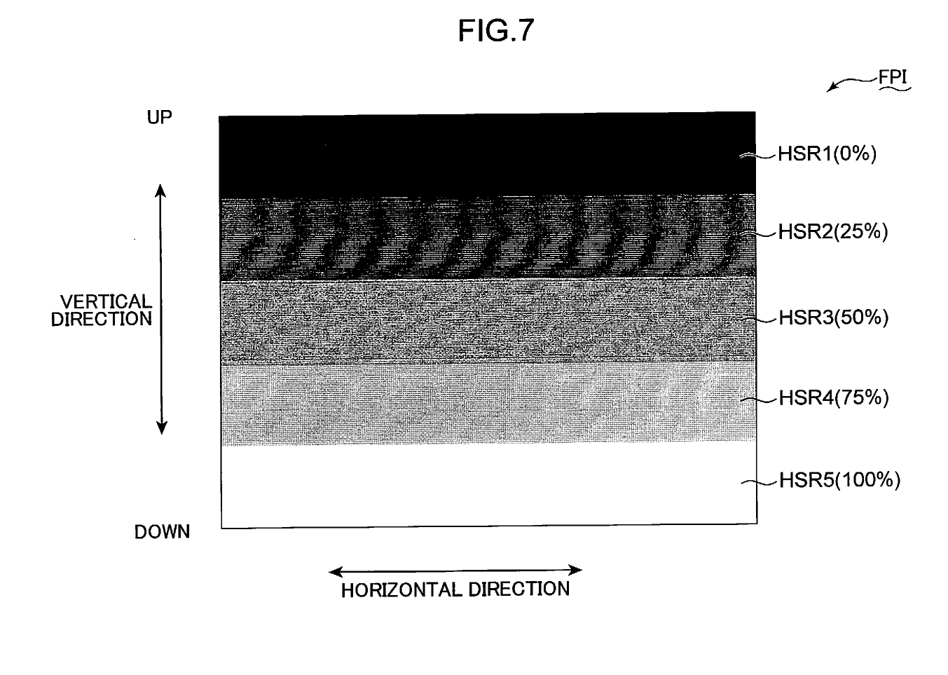

FIG. 7 is a schematic view of the first pattern image FPI. The first pattern image FPI includes five horizontal strip regions HSR1 to HSR5. The horizontal strip region HSR1 is the uppermost region in the first pattern image FPI. The horizontal strip region HSR5 is the lowermost region of the first pattern image FPI. The horizontal strip region HSR2 is the adjacent region to the horizontal strip region HSR1. The horizontal strip region HSR4 is the adjacent region to the horizontal strip region HSR5. The horizontal strip region HSR3 is the region between the horizontal strip regions HSR2, HSR4. In this implementation, the horizontal strip regions HSR1 to HSR5 aligned in the vertical direction are substantially identical in shape and size to each other. Alternatively, the horizontal strip regions HSR1 to HSR5 may be different in length or width from each other. In this implementation, each of the horizontal strip regions HSR1 to HSR5 is exemplified as the first main region.

In this implementation, a brightness level of the horizontal strip region HSR1 is “0%”. A brightness level of the horizontal strip region HSR5 is “100%”. The brightness level of “0%” means a voltage level of a video signal for the display surface 210 to depict an image with the lowest brightness. The brightness level of “100%” means a voltage level of a video signal for the display surface 210 to depict an image with the highest brightness. It should be noted that the definition of the aforementioned brightness level is provided so that the principle of this implementation is easily understood. However, the instant application is not limited by the aforementioned definitions of the brightness level.

A brightness level of the horizontal strip region HSR2 is “25%”. In other words, the horizontal strip region HSR2 is depicted in response to a video signal of a voltage level, which is “¼” of the voltage level of the video signal displaying the horizontal strip region HSR5. A brightness level of the horizontal strip region HSR3 is 50%.” In other words, the horizontal strip region HSR3 is depicted in response to a video signal of a voltage level, which is “½” of the voltage level of the video signal displaying the horizontal strip region HSR5. A brightness level of the horizontal strip region HSR4 is “75%”. In other words, the horizontal strip region HSR4 is depicted in response to a video signal of a voltage level, which is “¾” of the voltage level of the video signal displaying the horizontal strip region HSR5.

In this implementation, one of the horizontal strip regions HSR1 to HSR5 is exemplified as the first main region. For example, if the horizontal strip region HSR1 is exemplified as the first main region, the brightness level of “0%” is exemplified as the first brightness. One of the horizontal strip regions HSR2 to HSR5, which are depicted with a higher brightness level than the horizontal strip region HSR1, is exemplified as the second main region. For example, if the horizontal strip region HSR2 is exemplified as the second main region, the brightness level of “25%” is exemplified as the second brightness. One of the horizontal strip regions HSR3 to HSR5, which are depicted with a higher brightness level than the horizontal strip region HSR2, is exemplified as the third main region. For example, if the horizontal strip region HSR3 is exemplified as the third main region, the brightness level of “50%” is exemplified as the third brightness.

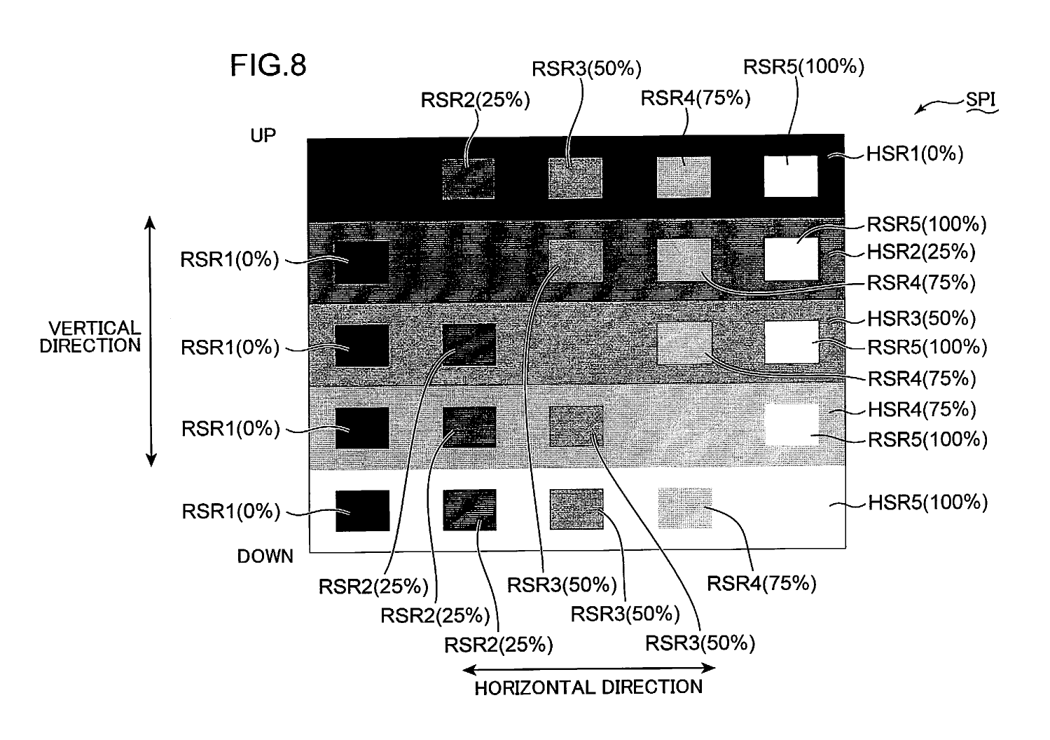

FIG. 8 is a schematic view of the second pattern image SPI. Like the first pattern image FPI, the second pattern image SPI includes the horizontal strip regions HSR1 to HSR5. The second pattern image SPI additionally includes rectangular regions RSR1 to RSR5, which are smaller than the horizontal strip regions HSR1 to HSR5. The rectangular region RSR1 is displayed at a brightness level of “0%”. The rectangular region RSR2 is displayed at a brightness level of “25%”. The rectangular region RSR3 is displayed at a brightness level of “50%”. The rectangular region RSR4 is displayed at a brightness level of “75%”. The rectangular region RSR5 is displayed at a brightness level of “100%”.

The four rectangular regions RSR2 to RSR5, which are depicted at different brightness levels from the brightness level of the horizontal strip region HSR1, are displayed in the horizontal strip region HSR1. The four rectangular regions RSR1, RSR3 to RSR5, which are depicted at different brightness levels from the brightness level of the horizontal strip region HSR2, are displayed in the horizontal strip region HSR2. The four rectangular regions RSR1, RSR2, RSR4, RSR5, which are depicted at different brightness levels from the brightness level of the horizontal strip region HSR3, are displayed in the horizontal strip region HSR3. The four rectangular regions RSR1 to RSR3, RSR5, which are depicted at different brightness levels from the brightness level of the horizontal strip region HSR4, are displayed in the horizontal strip region HSR4. The four rectangular regions RSR1 to RSR4, which are depicted at different brightness levels from the brightness level of the horizontal strip region HSR5, are displayed in the horizontal strip region HSR5.

In this implementation, each of the rectangular regions RSR1 to RSR5 is exemplified as the sub region. A group of the four rectangular regions RSR2 to RSR5 displayed in the horizontal strip region HSR1 may be exemplified as the first region group. Similarly, a group of the four rectangular regions RSR1, RSR3 to RSR5 displayed in the horizontal strip region HSR2 may be exemplified as the first region group. Similarly, a group of the four rectangular regions RSR1, RSR2, RSR4, RSR5 displayed in the horizontal strip region HSR3 may be exemplified as the first region group. Similarly, a group of the four rectangular regions RSR1 to RSR3, RSR5 displayed in the horizontal strip region HSR4 may be exemplified as the first region group. Similarly, a group of the four rectangular regions RSR1 to RSR4 displayed in the horizontal strip region HSR4 may be exemplified as the first region group.

In this implementation, each of the horizontal strip regions HSR1 to HSR5 is exemplified as the main region. Each of the horizontal strip regions HSR1 to HSR5 extends in the horizontal direction. Accordingly, the horizontal direction is exemplified as the first direction.

The four rectangular regions RSR1 depicted at a brightness level of “0%” are aligned in the vertical direction. Similarly, the four rectangular regions RSR2 depicted at a brightness level of “25%” are aligned in the vertical direction. Similarly, the four rectangular regions RSR3 depicted at a brightness level of “50%” are aligned in the vertical direction. Similarly, the four rectangular regions RSR4 depicted at a brightness level of “75%” are aligned in the vertical direction. Similarly, the four rectangular regions RSR5 depicted at a brightness level of “100%” are aligned in the vertical direction. In this implementation, the vertical direction is exemplified as the second direction. A group of the four rectangular regions RSR1 may be exemplified as the second region group. Similarly, a group of the four rectangular regions RSR2 may be exemplified as the second region group. Similarly, a group of the four rectangular regions RSR3 may be exemplified as the second region group. Similarly, a group of the four rectangular regions RSR4 may be exemplified as the second region group. Similarly, a group of the four rectangular regions RSR5 may be exemplified as the second region group. The group of the four rectangular regions RSR1, the group of the four rectangular regions RSR2, the group of the four rectangular regions RSR3, the group of the four rectangular regions RSR4, and the group of the four rectangular regions RSR5 are aligned substantially at regular intervals in the horizontal direction.

### (Principle of Crosstalk Generation)

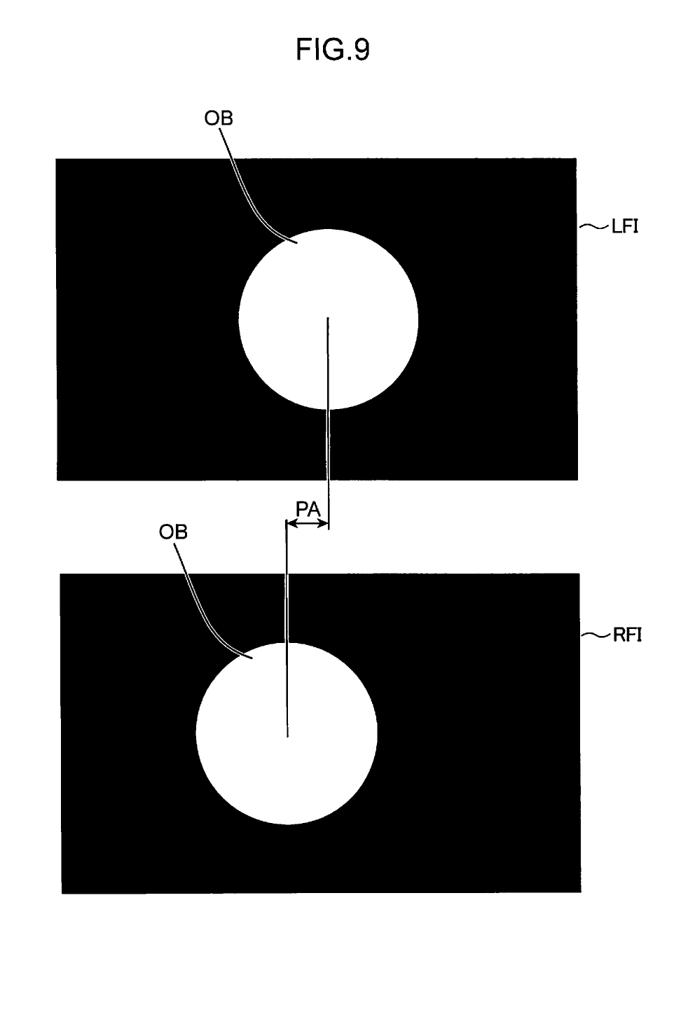

FIG. 9 schematically shows frame images, which are used for displaying a stereoscopic image. The principle of the crosstalk generation is described with reference to FIG. 9. In order to display a stereoscopic image, the left frame image LFI, which is viewed by the left eye, and the right frame image RFI, which is viewed by the right eye, are alternately displayed on the display surface 210. FIG. 9 shows the left frame image LFI in which a black (brightness level: 0%) background and a white (brightness level: 100%) object OB are depicted. FIG. 9 also shows the right frame image RFI in which a black (brightness level: 0%) background and a white (brightness level: 100%) object OB are depicted. The position of the object OB on the display surface is shifted between the left and right frame images LFI, RFI by a distance PA. If an observer views the left frame image LFI with the left eye and the right frame image RFI with the right eye, the observer perceives the shift amount of the object OB by the distance PA to synthesize the left and right frame images LFI, RFI in the brain. Consequently, the observer perceives the object OB that pops up from or recedes into the display surface.

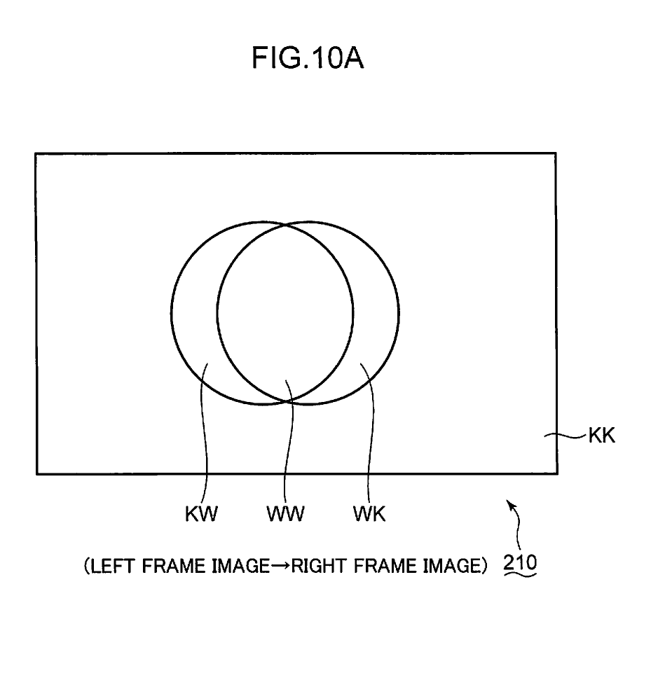

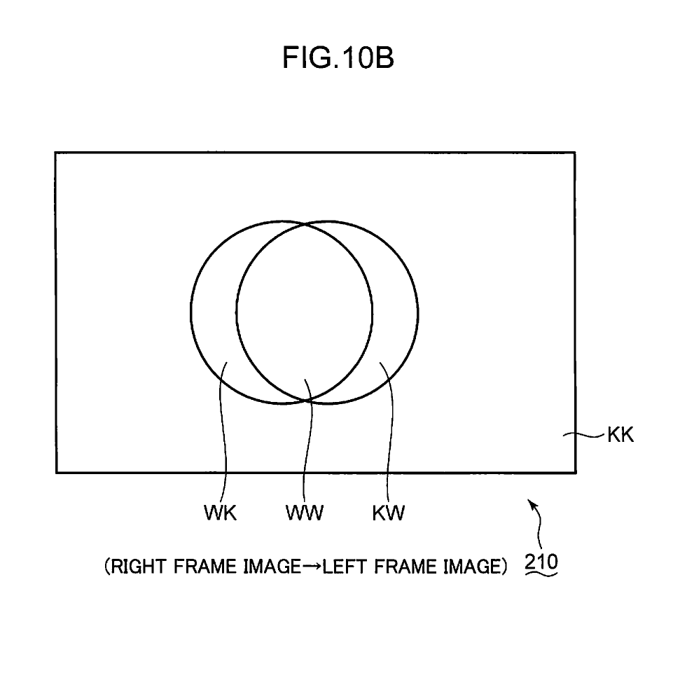

FIG. 10A is a schematic view of regional segments of the display surface 210, which switches the image display from the left frame image LFI to the right frame image RFI. FIG. 10B is a schematic view of regional segments of the display surface 210, which switches the image display from the right frame image RFI to the left frame image LFI. The principle of the crosstalk generation is further described with reference to FIGS. 9 to 10B.

The display surface 210 is roughly divided into four regions on the basis of a change in brightness level, which occurs upon switching the image display between the left and right frame images LFI, RFI. The region KK shown in FIGS. 10A and 10B maintains the brightness level of “0%” (black) during the switching of the image display. The region WW shown in FIGS. 10A and 10B maintains the brightness level of “100%” (white) during the switching of the image display. In the region KW shown in FIGS. 10A and 10B, a change in brightness level from “0%” (black) to “100%” (white) occurs as a result of switching the image display. In the region WK shown in FIGS. 10A and 10B, a change in brightness level from “100%” (white) to “0%” (black) occurs as a result of switching the image display. Distinct crosstalk tends to occur in the regions KW, WK where the brightness level largely changes.

When the image display is switched from the right frame image RFI to the left frame image LFI, the region WK is ideally completely black (brightness level: 0%). In many cases, the region WK is, however, not completely black (brightness level: 0%), for example, because of delay in response of elements (liquid crystals or plasma emitting elements), which are used for the display surface 210. In the ensuing description, crosstalk arising in regions in which a change from a high brightness level to a low brightness level is referred to as “falling crosstalk”.

When the image display is switched from the right frame image RFI to the left frame image LFI, the region KW is ideally completely white (brightness level: 100%). In many cases, the region KW is, however, not completely white (brightness level: 100%), for example, because of delay in response of elements (liquid crystals or plasma emitting elements), which are used for the display surface 210. In the ensuing description, crosstalk arising in regions in which a change from a low brightness level to a high brightness level is referred to as “rising crosstalk”.

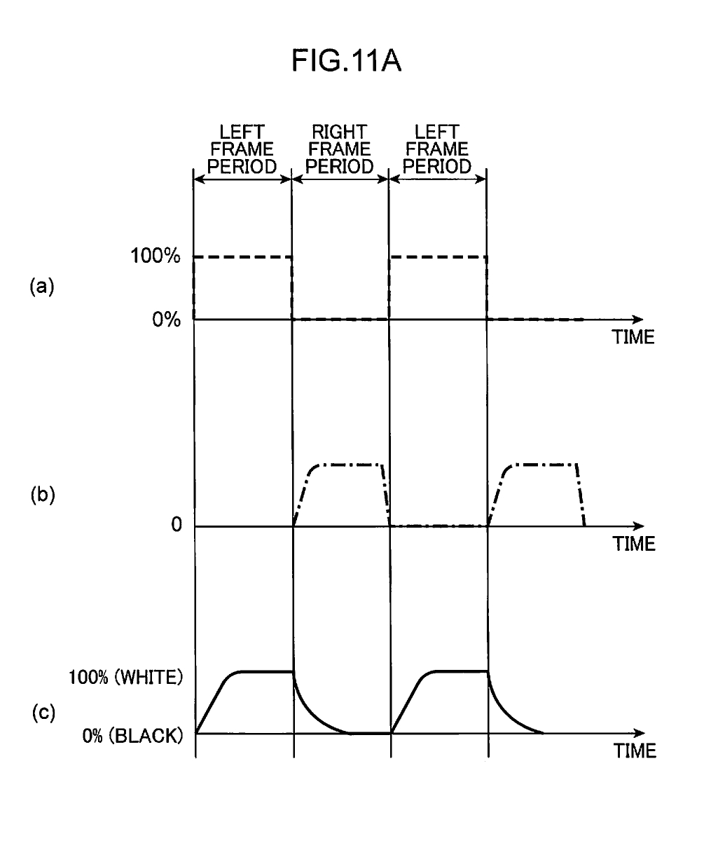

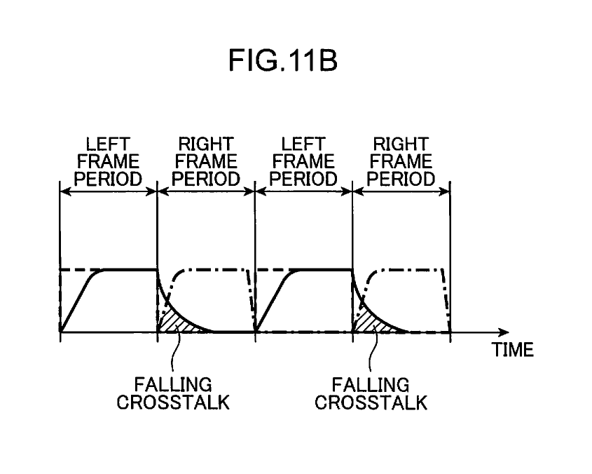

FIG. 11A is a schematic timing chart showing the falling crosstalk, which is perceived by the right eye. FIG. 11B is a timing chart, in which the graphs shown in FIG. 11A are superimposed. The falling crosstalk is described with reference to FIGS. 9 to 11B. The dotted line in the section (a) of FIG. 11A schematically shows a voltage fluctuation of a video signal for the region WK. If the voltage value of the video signal is “100%”, the video signal instructs the display surface 210 to display a white image. If the voltage value of the video signal is “0%”, the video signal instructs the display surface 210 to display a black image. The voltage value of the video signal is “100%” in a left frame period, during which the left frame image LFI is displayed whereas the voltage value of the video signal is “0%” in the right frame period.

The dashed-dotted line in the section (b) of FIG. 11A represents a fluctuation in a transmitted light amount to the right eye. In response to the shutter operation of the eyewear device, little light is transmitted to the right eye during the left frame period whereas the transmitted light amount to the right eye increases during the right frame period.

The solid line in the section (c) of FIG. 11A represents an actual change in brightness of the region (region WK or KW) on the display surface 210. The brightness of the region gradually changes from “100%” (white) to “0%” (black) although the video signal shown in the section (a) of FIG. 11A instantaneously drops from “100%” to “0%” upon switching from the left frame period to the right frame period. The delay in the actual change in brightness of the display surface 210 from the change of the video signal is perceived as the crosstalk by the observer.

Like FIG. 11A, the dotted line, dashed-dotted line and solid line of FIG. 11B represent the video signal, the transmitted light amount to the right eye, and the change in brightness of the region (region WK or KW), respectively. An area of the hatched region (region surrounded by the dashed-dotted line, solid line and time axis) shown in FIG. 11B represents an amount of the falling crosstalk. If the area of the hatched region is large, the observer may perceive distinct falling crosstalk. If the area of the hatched region is small, the observer perceives little falling crosstalk.

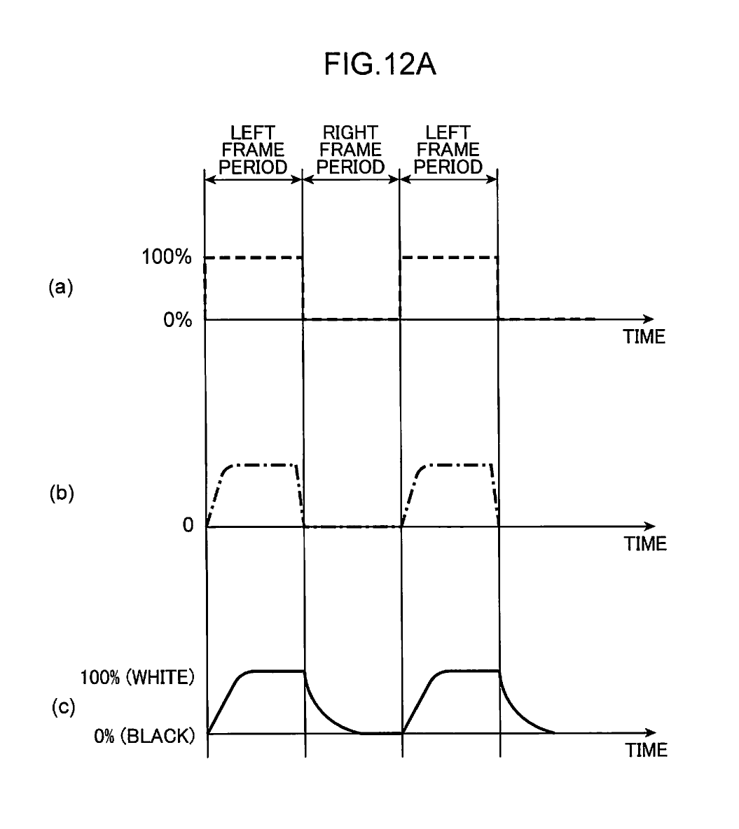

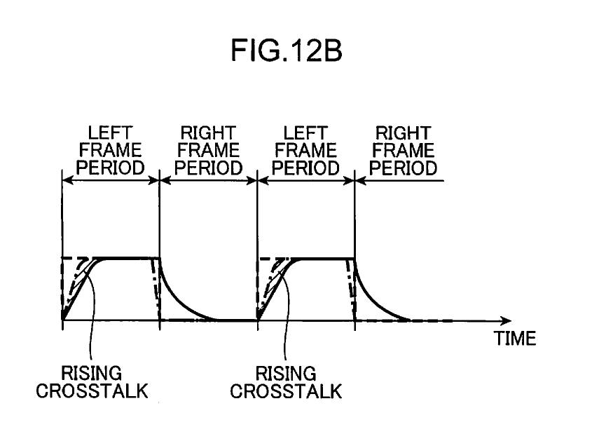

FIG. 12A is a schematic timing chart showing the rising crosstalk, which is perceived by the left eye. FIG. 12B is a timing chart in which the graphs shown in FIG. 12A are superimposed. The rising crosstalk is described with reference to FIGS. 9 to 12B. The sections (a) and (c) of FIG. 12A are the same as the sections (a) and (c) of FIG. 11A. The section (b) of FIG. 12A represents a fluctuation in a transmitted light amount to the left eye. The brightness of the region gradually changes from “0%” (black) to “100%” (white) although the video signal shown in the section (a) of FIG. 12A instantaneously increases from “0%” to “100%” upon switching from the right frame period to the left frame period. The delay in the actual brightness change on the display surface 210 from the change of the video signal is perceived as the crosstalk by the observer.

Like FIG. 12A, the dotted line, dashed-dotted line and solid line of FIG. 12B represent the video signal, the transmitted light amount to the right eye, and the change in brightness of the region (region WK or KW), respectively. An area of the hatched region (region surrounded by the solid line and time axis in the left frame period) shown in FIG. 12B represents an amount of the rising crosstalk. If the area of the hatched region is large, the observer may perceive distinct rising crosstalk. If the area of the hatched region is small, the observer may perceive little rising crosstalk.

### (Quantification of Crosstalk)

The quantification of the crosstalk is described with reference to FIGS. 1, 10A and 10B. The following Equation 1 is a quantification equation of the falling crosstalk.

$${CT}_{D} = \frac{{Y}_{W , K} - {Y}_{K , K}}{{Y}_{K , W} - {Y}_{K , K}} \times 100 \% \qquad [ Equation 1 ]$$

In Equation 1, “CT_{D}” is a quantified value of the falling crosstalk. “Y_{W, K}” is brightness of the region WK. “Y_{K, K}” is brightness of the region KK. “Y_{K, W}” is brightness of the region KW. The brightness data about “Y_{W, K}”, “Y Y_{K, K}” and “Y_{K, W}” are acquired by the image capturing system 400. It should be noted that Equation 1 is an exemplary equation for quantifying the falling crosstalk. Accordingly, the falling crosstalk may be quantified by means of other mathematical techniques.

The following Equation 2 is a quantification equation of the rising crosstalk.

$${CT}_{U} = \frac{{Y}_{K , W} - {Y}_{W , W}}{{Y}_{K , W} - {Y}_{K , K}} \times 100 \% \qquad [ Equation 2 ]$$

In Equation 2, “CT_{U}” is a quantified value of the rising crosstalk. “Y_{W, W}” is brightness of the region WW. The brightness data about “Y_{W, W}” is also acquired by the image capturing system 400. It should be noted Equation 2 is an exemplary equation for quantifying the rising crosstalk. Accordingly, the rising crosstalk may be quantified by means of other mathematical techniques.

(Quantification of Crosstalk using Pattern Image)

The foregoing methods for quantifying crosstalk are applied to the display switching between white display and black display. The foregoing method may be, however, applied to crosstalk caused by a change in brightness in an intermediate gradation. The pattern images described with reference to FIGS. 7 and 8 include several regions which are depicted in intermediate gradations, in addition to the white and black regions. Accordingly, the pattern images described with reference to FIGS. 7 and 8 may be suitably used for evaluating crosstalk under various brightness changes.

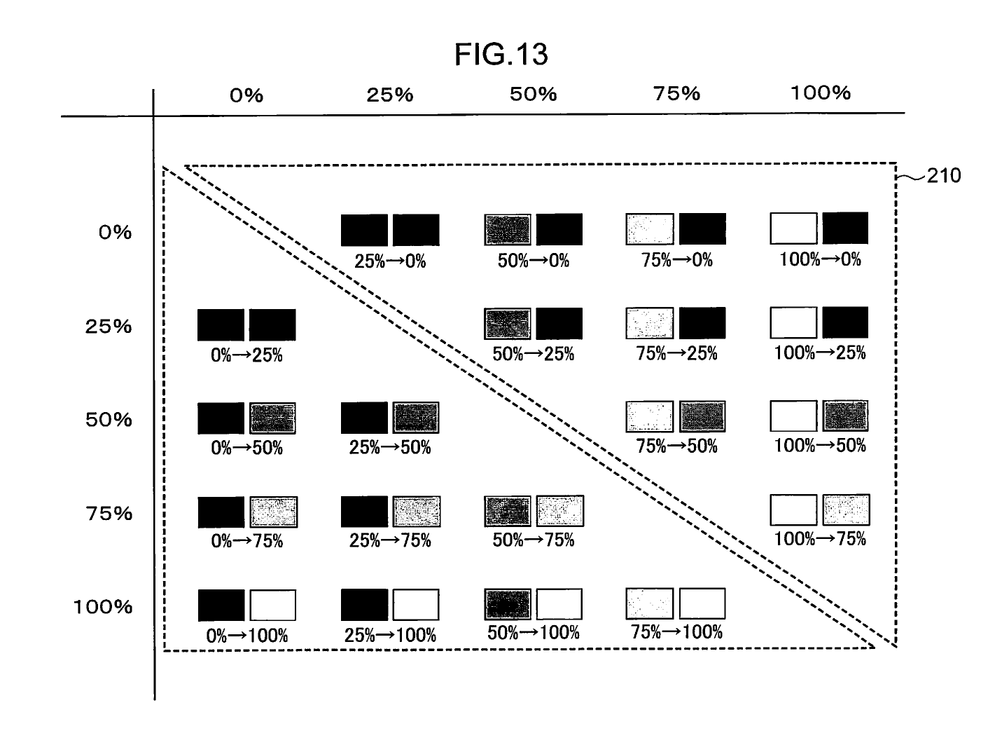

FIG. 13 is a schematic view showing a change in brightness upon alternately displaying the first and second pattern images FPI, SPI described with reference to FIGS. 7 and 8, respectively. Crosstalk quantification by means of the pattern images is described with reference to FIGS. 7, 8 and 13. FIG. 13 shows the change in brightness of the display surface 210 when the first pattern image FPI is displayed after the second pattern image SPI is displayed. Numerical values indicated above the display surface 210 shown in FIG. 13 represent brightness levels of the rectangular regions RSR1 to RSR5 of the second pattern image SPI. Numerical values indicated on the left of the display surface 210 shown in FIG. 13 represent brightness levels of the horizontal strip regions HSR1 to HSR5 of the first pattern image FPI.

Several pairs of oblong regions are indicated on the display surface 210 shown in FIG. 13. The left one of the paired oblong regions represents the rectangular regions RSR1 to RSR5 of the second pattern image SPI. The right one of the paired oblong regions represents the horizontal strip regions HSR1 to HSR5 at corresponding positions to the rectangular regions RSR1 to RSR5. The numerical values indicated below the paired oblong regions represent resultant changes in brightness level from the switching from the second pattern image SPI to the first pattern image FPI.

The following Equation 3 is used for quantifying the crosstalk, which is generated by means of the first and second pattern images FPI, SPI. The Equation 3 is an exemplary equation for quantifying crosstalk. Accordingly, crosstalk may be quantified by means of other mathematical techniques.

$$CT = \frac{\frac{1}{n} {\sum }_{n} \vert {Y}_{x \% , y \%} - {Y}_{y \% , y \%} \vert}{( {Y}_{100 \% , 100 \%} - {Y}_{0 \% , 0 \%} )} \qquad [ Equation 3 ]$$

In Equation 3, “CT” is a quantified value of the crosstalk. “n” represents a number of regions in which the brightness changed. “n” is “20” in the crosstalk generation simulation model depicted in FIG. 13. “x %” refers to a brightness level of the previously displayed image. Specifically, “x %” refers to the brightness level of each of the rectangular regions RSR1 to RSR5 in the crosstalk generation simulation model depicted in FIG. 13. “y %” refers to a brightness level of the subsequently displayed image. Specifically, “y %” refers to the brightness level of each of the horizontal strip regions HSR1 to HSR5 in the crosstalk generation simulation model depicted in FIG. 13. “Y_{x %, y %}” refers to a brightness value, which is actually measured in a region where the brightness level of “x %” is changed to the brightness level of “y %”. For example, the brightness value of the rectangular region RSR3 indicated in the horizontal strip region HSR4 is depicted as “Y_{50%, 75%}”. “Y_{y %, y %}” refers to a brightness level, which is actually measured in a region where the brightness level of “y %” is maintained.

In FIG. 13, two triangular regions are represented with dotted lines as the display surface 210. The paired oblong regions indicated in the upper triangular region are a group in which the brightness level decreases pursuant to the display switching from the second pattern image SPI to the first pattern image FPI. The paired oblong regions indicated in the lower triangular region are a group in which the brightness level increases pursuant to the display switching from the second pattern image SPI to the first pattern image FPI. The brightness level is maintained during the display switching from the second pattern image SPI to the first pattern image FPI in the regions on the oblique lines of the two triangular regions. For example, the brightness level of “75%” is maintained in the region between the rectangular region RSR3 depicted in the horizontal strip region HSR4 and the rectangular region RSR5 depicted in the horizontal strip region HSR4.

In Equation 3, “Y_{100%, 100%}” refers to a brightness value, which is actually measured in a region in which the brightness level of “100%” is maintained. In the crosstalk generation simulation model shown in FIG. 13, the brightness value which is measured in the region of the lower right corner of the pattern image (first and second pattern images FPI, SPI) corresponds to “Y_{100%, 100%}”.

In Equation 3, “Y_{0%, 0%}” refers to a brightness value, which is actually measured in a region in which the brightness level of “0%” is maintained. In the crosstalk generation simulation model shown in FIG. 13, the brightness value which is measured in the region of the upper right corner of the pattern image (first and second pattern images FPI, SPI) corresponds to “Y_{0%, 0%}”.

An average value of the crosstalk that arises under various changes in brightness level is calculated by means of Equation 3.

### (Performance Evaluation of Display Device)

Overall performance evaluation of the display device 200 about the crosstalk is suitably executed by means of the foregoing methods of calculating the average value of the crosstalk.

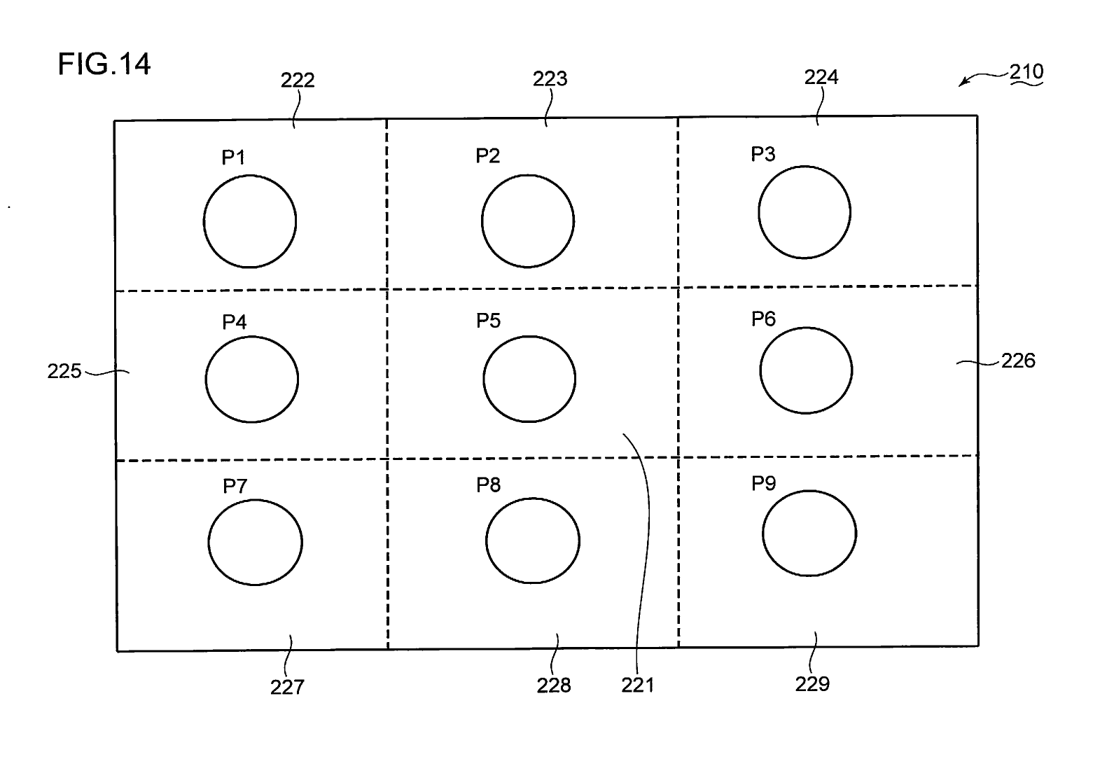

FIG. 14 is a schematic view showing measurement positions of brightness values for calculating an average value of the crosstalk. The method for evaluating performance of the display device 200 is described with reference to FIGS. 1, 3, 4 and 14. As described with reference to FIGS. 3 and 4, the first and second pattern images FPI, SPI are displayed in each of the display regions 221 to 229. As described with reference to FIG. 1, the image capturing system 400 may take an image of the entire display surface 210. Accordingly, the average value “CT” of the crosstalk is calculated for each of the display regions 221 to 229 on the basis of the image data acquired by the image capturing system 400. FIG. 14 shows the measurement positions P1 to P9 of the brightness value provided to each of the display regions 221 to 229.

The following Equation 4 is used for calculating the average value of the crosstalk over the entire display surface 210.

$${CT}_{total} = \frac{\begin{matrix}{CT}_{P 1} + {CT}_{P 2} + {CT}_{P 3} + {CT}_{P 4} + \\ {CT}_{P 5} + {CT}_{P 6} + {CT}_{P 7} + {CT}_{P 8} + {CT}_{P 9}\end{matrix}}{9} \qquad [ Equation 4 ]$$

In Equation 4, “CTₜₒₜₐₗ” represents the average value of the crosstalk over the entire display surface 210. “CT_{P1}” to “CT_{P9}” refer to the “CT”, which is obtained in each of the measurement positions P1 to P9.

### (Detection Method of Crosstalk)

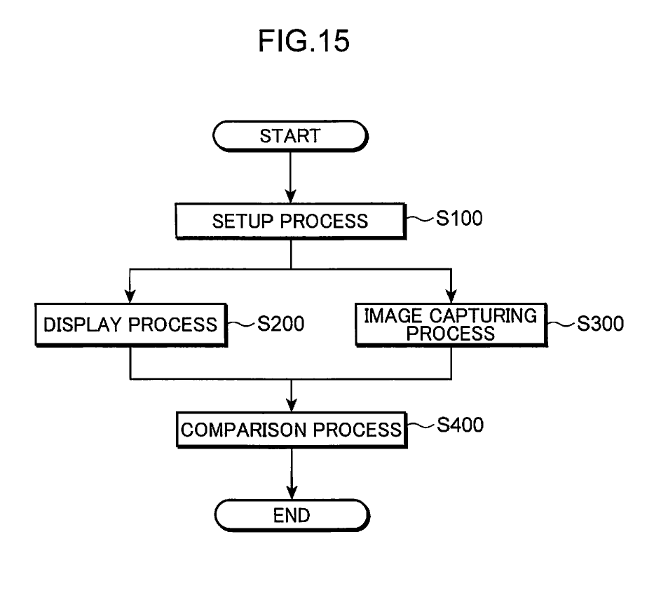

FIG. 15 is a schematic flowchart of a method for detecting the crosstalk, which appears on the display surface 210 of the display device 200. The method for detecting the crosstalk is described with reference to FIGS. 1, 3, 4 and 15. In step S100, a setup process is executed. In the setup process, the signal generating device 300 is connected to the display device 200. The image capturing system 400 is then installed in position with respect to the display device 200. Subsequently, steps S200 and S300 are executed.

In step S200, a display process is executed. In the display process, the first and second images FI, SI are alternately displayed on the display surface 210. In step S300, which is executed in parallel with step S200, an image capturing process is executed. In the image capturing process, the camera device 410 takes an image of the display surface 210, which alternately displays the first and second images FI, SI, and outputs the image data to the processing device 420. When the image data required for the foregoing crosstalk quantification process are obtained, step S400 is executed.

In step S400, a comparison process is executed. In the comparison process (step S400), the processing device 420 analyzes brightness of regions, in which the rectangular regions RSR1 to RSR5 are displayed, and/or brightness of regions, in which the horizontal strip regions HSR1 to HSR5 on the diagonal line (diagonal line connecting the upper left corner and the lower right corner) in the second pattern image SPI are displayed, for each of the display regions 221 to 229 on the basis of the image data acquired from the camera device 410. Consequently, data about the parameters “Y_{x %, y %}”, “Y_{y %, y %}”, “Y_{100%, 100%}” and “Y_{0%, 0%}” in the equation for calculating the foregoing “CT” are obtained.

In this implementation, the processing device 420 uses the second image SI as the previously displayed image to calculate the “CT”. Accordingly, the difference calculation between “Y_{x %, y %}” and “Y_{y %, y %}” indicated as a numerator of the equation for calculating the foregoing “CT” refers to comparison of actually acquired brightness with brightness of the first image FI displayed after the second image SI. It should be noted that the processing device 420 may handle the first image FI as the previously displayed image instead of the second image SI.

The processing device 420 calculates the “CT” (“CT_{P1}” to “CT_{P9}”) for each of the display regions 221 to 229. The processing device 420 may additionally calculate “CTₜₒₜₐₗ”, the maximum value of “CT” or standard deviation of “CT” by means of the acquired data about “CT_{P1}” to “CT_{P9}”. Consequently, the processing device 420 may detect various types of information about the crosstalk.

### (Setup Process)

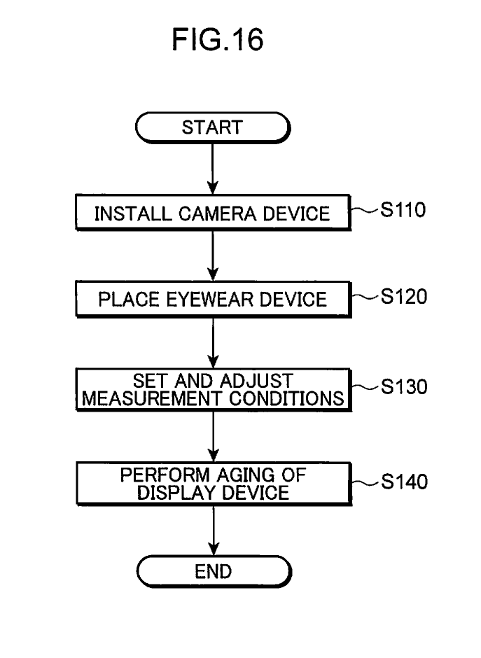

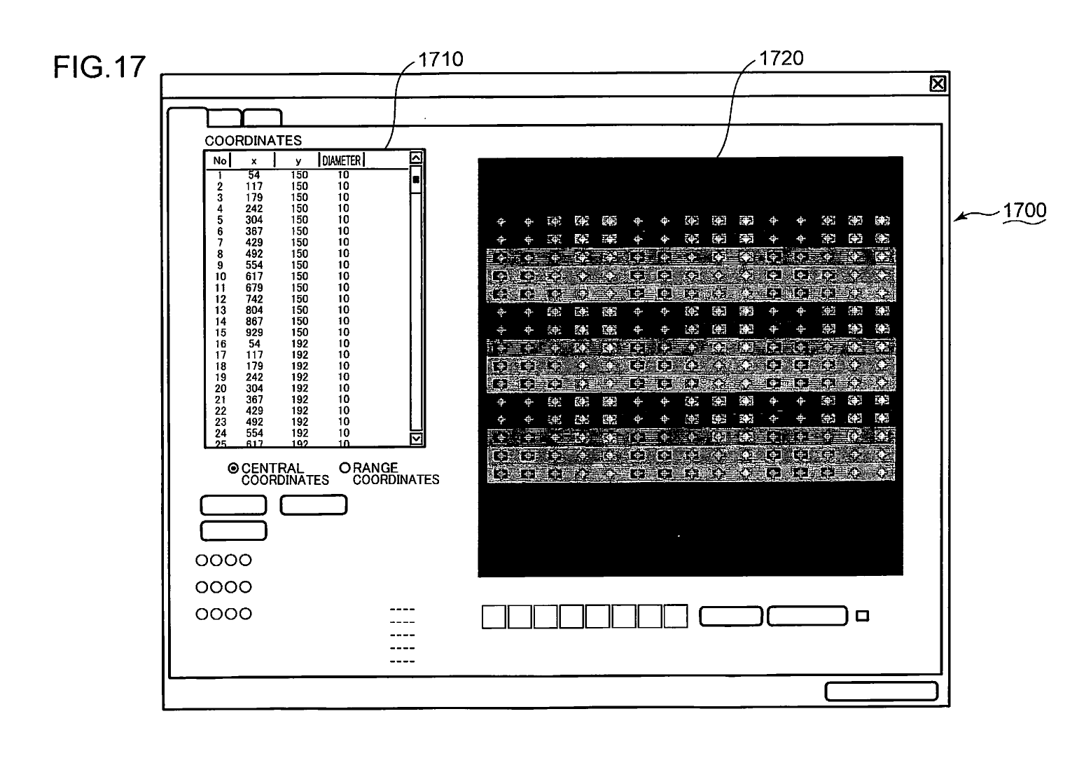

FIG. 16 is a schematic flowchart of the setup process. FIG. 17 is a schematic view showing an exemplary screen 1700 for setting measurement conditions in the setup process. The setup process is described with reference to FIGS. 1, 3, 4, 16 and 17. The setup process begins with step S110. In step S110, the camera device 410 is positioned approximately 3 times the height dimension “H” of the display surface 210 (e.g., 3×H) from the display surface 210. Focus and other optical settings of the camera device 410 are then adjusted so that the camera device 410 may take an image of the entire display surface 210. The processing device 420 is electrically connected to the camera device 410. Subsequently, step S120 is executed.

In step S120, the shutter device 450 is placed in front of the camera device 410. Consequently, crosstalk may be measured under a similar environment to an environment in which an observer uses the display device 200 to observe a stereoscopic image. Subsequently, step S130 is executed. In step S130, the measurement conditions are set and adjusted. For example, if a frame rate of the display device 200 is 120 Hz (first image FI: 60 Hz, second image SI: 60 Hz), a measurement frequency of the image capturing system 400 is set to 60 Hz. In this implementation, “5×5×9” measurement positions ((number of regions in which the rectangular regions RSR1 to RSR5 are displayed x number of regions in which the horizontal strip regions HSR1 to HSR5 on the diagonal line (diagonal line connecting the upper left corner to the lower right corner) in the second pattern image SPI are displayed)×number of display regions 221 to 229) are set for the entire display surface 210. The brightness measurement positions are set in the image data. For example, the processing device 420 may display the screen 1700 shown in FIG. 17. The screen 1700 mainly includes an interface screen 1710 and a view screen 1720. The interface screen 1710 has “x-column”, “y-column” and “diameter-column”. A user may input values to “x-column” and “y-column” to determine positions where the brightness is measured”. The user may then input values to “diameter-column” to determine a size of each determined position. The input value is reflected to the view screen 1720, which shows the aforementioned set-up so that the user intuitively confirms whether the input data are appropriate. Optionally, exposure adjustment of the camera device 410 may be executed. Subsequently, step S140 is executed.

In step S140, aging of the display device 200 is performed. For example, the display surface 210 continues for 30 minutes or 1 hour or longer to display an image. Consequently, the display device 200 is sufficiently warmed up to stabilize operation of the display device 200 during the foregoing display process. It should be noted that step S140 may be performed before step S130.

### (Display Process and Image Capturing Process)

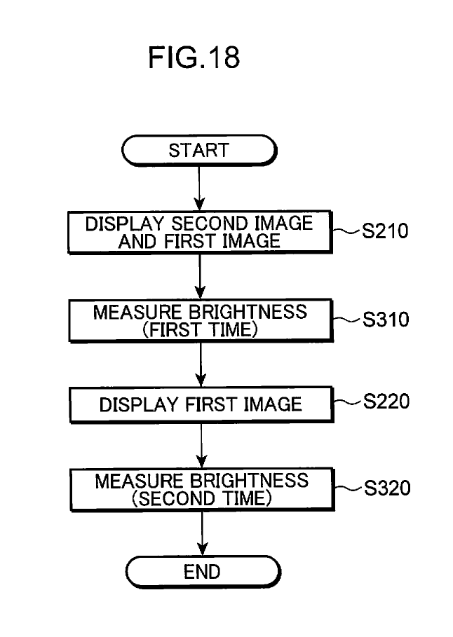

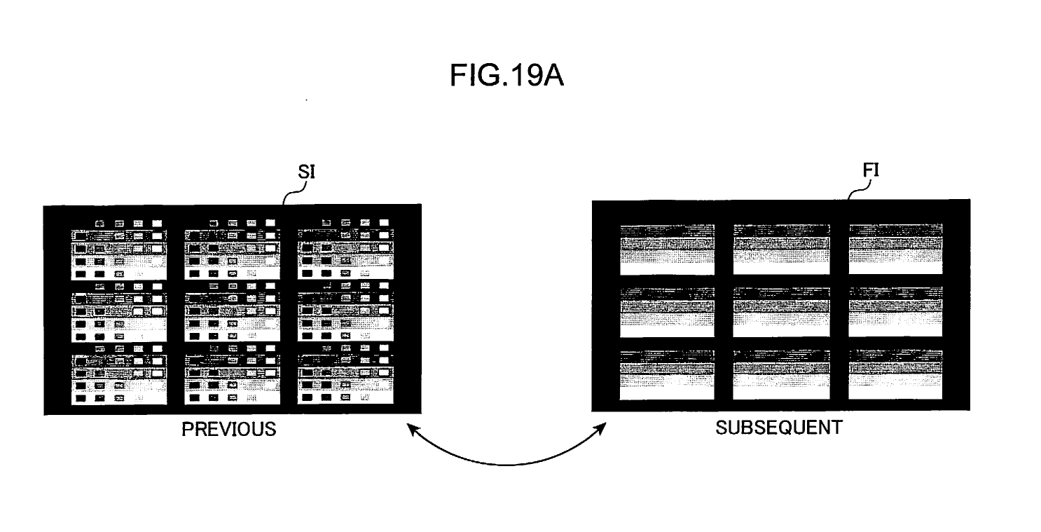

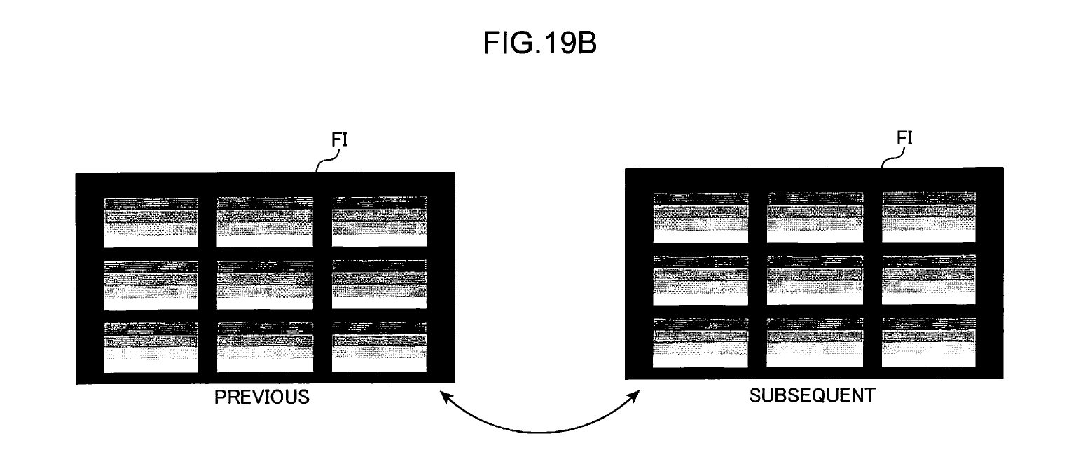

FIG. 18 is a schematic flowchart of the display process and the image capturing process. FIGS. 19A and 19B are schematic views of a combination of images, which are used in the display process. The display process and the image capturing process are described with reference to FIGS. 1, 3, 4, 15 and FIGS. 18 to 19B. The display process begins with step S210. In step S210, the second signal for displaying the second image SI and the first signal for displaying the first image FI are alternately output from the signal generating device 300 to the display device 200. Consequently, the display device 200 alternately displays the second and first images SI, FI on the display surface 210 as shown, for example, in FIG. 19A. It should be noted that the second image SI is used as a previously displayed video in the comparison process as described above. Once the alternate display of the second and first images SI, FI is started, step S310 is executed. It should be noted that step S210 is included in the display process.

In step S310, the camera device 410 takes an image of the display surface 210, and then outputs the image data about the display surface 210 to the processing device 420. The processing device 420 measures brightness by means of the image data at the measurement positions, which are set in the setup process. Consequently, the processing device 420 acquires the data about “Y_{x %, y %}” which is used for calculating the foregoing “CT”. It should be noted that the processing device 420 may measure brightness at the measurement positions, which are set at the upper left corner and lower right corner of the second and first pattern images SPI, FPI in the setup process. Consequently, the processing device 420 acquires the data about “Y_{100%, 100%}” and “Y_{0%, 0%}”, which is used for calculating the foregoing “CT”. Subsequently, step S220 is executed. It should be noted that step S310 is included in the image capturing process.

In step S220, the first signal for displaying the first image FI is repeatedly output from the signal generating device 300 to the display device 200. Consequently, the display device 200 repeatedly displays the first image FI on the display surface 210 (c.f., FIG. 19B). Once the repeated display of the first image FI is started, step S320 is executed. It should be noted that step S220 is included in the display process.

In step S320, the camera device 410 takes an image of the display surface 210, and then outputs the image data about the display surface 210 to the processing device 420. The processing device 420 measures brightness on the basis of the image data at the measurement positions, which are set in the setup process. Consequently, the processing device 420 acquires the data about “Y_{y %, y %}”, “Y_{100%, l00%}” and “Y_{0%, 0%}”, which are used for calculating the foregoing “CT”. Alternatively, the processing device 420 may use brightness at the measurement positions, which are set on the diagonal line connecting the upper left corner to the lower right corner of the second or first pattern image SPI, FPI for acquiring the data about “Y_{y %, y %}”, “Y_{100%, 100%}” and “Y_{0%, 0%}”. In the foregoing case, steps S220 and S320 may be omitted. In the foregoing case, the crosstalk data may contain, however, errors caused by a shift of the measurement positions because the measurement positions, for which data about “Y_{y %, y %}”, “Y_{100%, l00%}” and “Y_{0%, 0%}” are acquired, are different from the measurement positions, for which data about “Y_{x %, y %}” are acquired.

### (Measurement Results of Crosstalk)

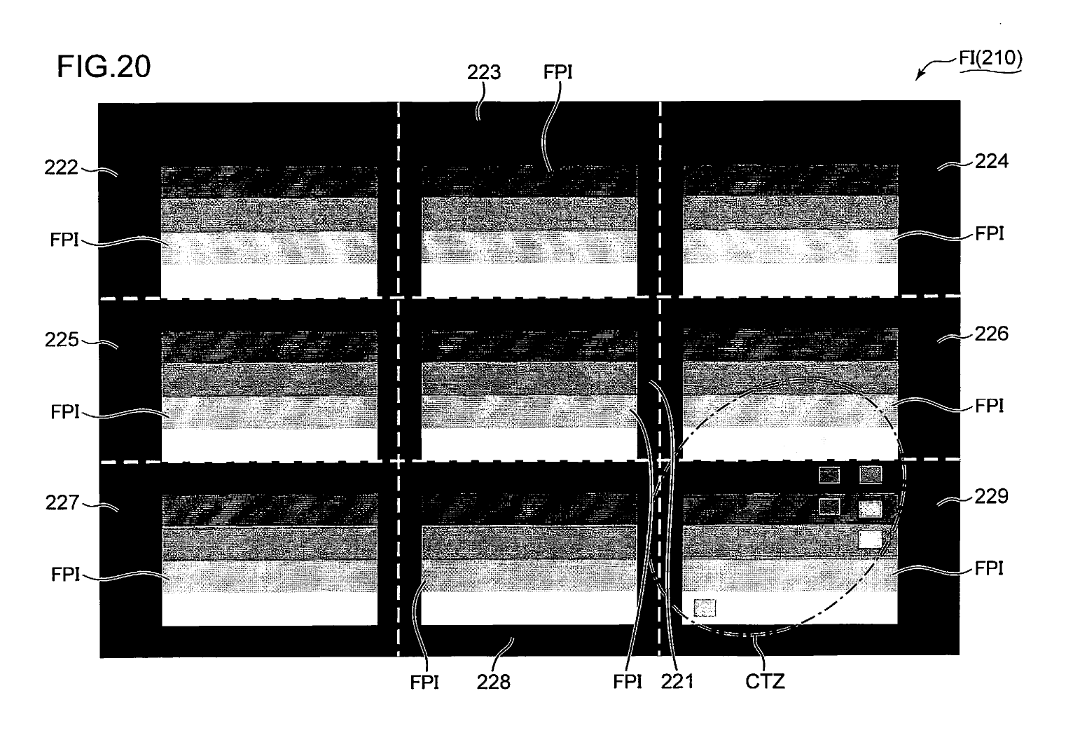

FIG. 20 is a schematic view showing results of the crosstalk, which are obtained from the foregoing measurement. The foregoing measurement enables evaluation of the crosstalk in each of the display regions 221 to 229. In this implementation, the display surface 210 is conceptually compartmentalized into the substantially identical nine display regions 221 to 229. The identical first pattern images FPI and the identical second pattern images SPI are displayed over the display regions 221 to 229. Accordingly, the crosstalk, which is measured for each of the display regions 221 to 229, is quantitatively evaluated.

According to the measurement results shown in FIG. 20, distinct crosstalk is observed in the display regions 226, 229 (region CTZ). Accordingly, a user may understand that the display performance improves by changing brightness characteristics of the display regions 226, 229. It should be noted that the user may adjust parameters of crosstalk cancellation process (not shown) for increasing or decreasing at least one of the left or right voltage level (signal level) of a specific region in response to generated crosstalk.

### (Manufacturing Method of Display Device)

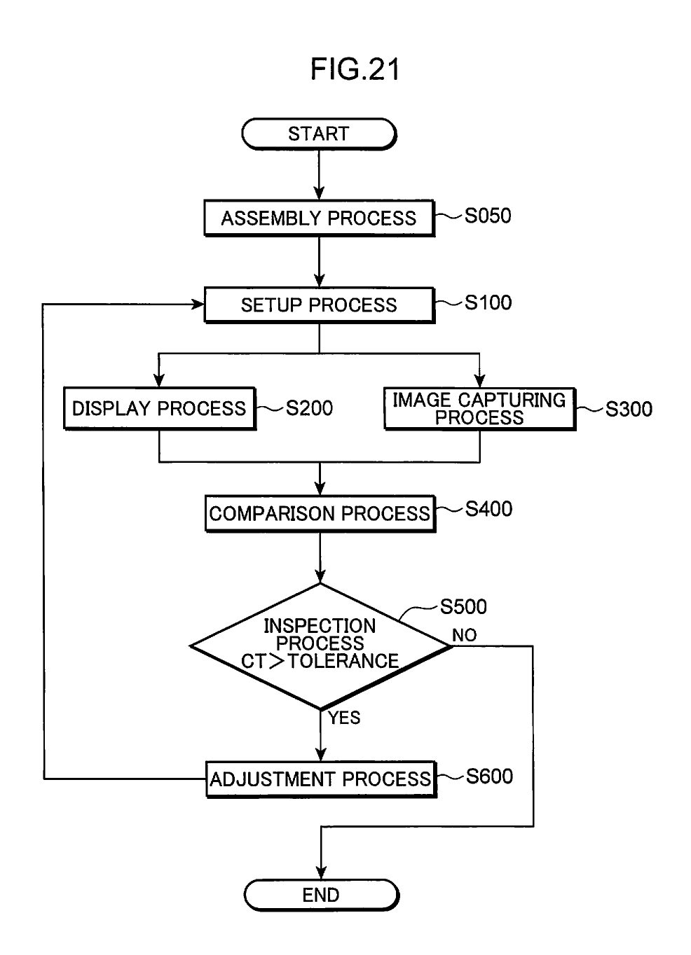

As described above, if the display device 200 is manufactured on the basis of the crosstalk measurement results, the display device 200 may display high quality images (i.e., images with little crosstalk). FIG. 21 is a schematic flowchart of the manufacturing process of the display device 200. The manufacturing method of the display device 200 is described with reference to FIGS. 1, 6 15, 20 and 21.

The manufacturing process begins with the execution of the assembly process (step S050). In the assembly process, a display portion such as a liquid crystal display panel or a plasma display panel is built into the housing 211 so as to prepare the display device 200. Subsequently, the setup process (step S100), the display process (step S200), the image capturing process (step S300) and the comparison process (step S400), which are described with reference to FIG. 15 are executed. After the comparison process (step S400), step S500 is executed.

In step S500, an inspection process is executed. A tolerance (threshold) is set in advance for the “CT” (“CT_{P1}” to “CT_{P9}”), which is calculated in the comparison process. If “CT” exceeding the tolerance appears in at least one of the display regions 221 to 229, step S600 is executed. Otherwise, the manufacturing process is ended, and the display device 200 is completed.

In step S600, an adjustment process is executed. According to the results, which are described with reference to FIG. 20, distinct crosstalk (“CT” exceeding the tolerance) appears on the display regions 226, 229. Accordingly, a user may ascertain that brightness characteristics of the display regions 226, 229 have to be adjusted. The adjuster 250 described with reference to FIG. 6 allows for the selective adjustment of the brightness characteristics for each of the display regions 221 to 229. Accordingly, the user who obtains the measurement results described with reference to FIG. 20 may operate the adjuster 250 to adjust the brightness characteristics of the display regions 226, 229. Subsequently, step S100 is executed once again to inspect the crosstalk.

### (Other Calculation Methods of Crosstalk)

The equation for calculating the foregoing quantitative value of the crosstalk (“CT”) uses a difference value between the brightness (“Y_{100%, 100%}”) of the regions, which are displayed by a signal voltage value for displaying white, and the brightness (“Y_{0%, 0%}”) of the regions, which are displayed by a signal voltage value for displaying black. Alternatively, the quantitative value of the crosstalk may be calculated by means of other calculation equations.

The following Equation 5 is used if brightness of the previously displayed image pattern is higher than brightness of the subsequently displayed image pattern (x %>y %). In other words, Equation 5 is used for evaluation of the crosstalk in a pattern displayed in the upper triangular region shown in FIG. 13.

$$CT = \frac{\frac{1}{n} {\sum }_{n} \vert {Y}_{x \% , y \%} - {Y}_{y \% , y \%} \vert}{( {Y}_{x \% , x \%} - {Y}_{y \% , y \%} )} \qquad [ Equation 5 ]$$

The following Equation 6 is used if brightness of the previously displayed image pattern is lower than brightness of the subsequently displayed image pattern (x %<y %). In other words, Equation 6 is used for evaluation of the crosstalk in the pattern displayed in the lower triangular region shown in FIG. 13.

$$CT = \frac{\frac{1}{n} {\sum }_{n} \vert {Y}_{x \% , y \%} - {Y}_{y \% , y \%} \vert}{( {Y}_{y \% , y \%} - {Y}_{x \% , x \%} )} \qquad [ Equation 6 ]$$

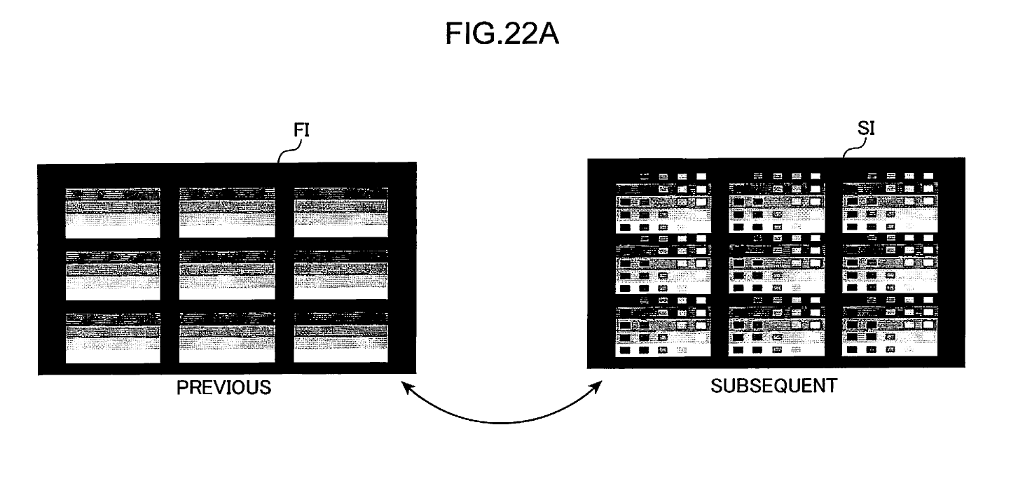

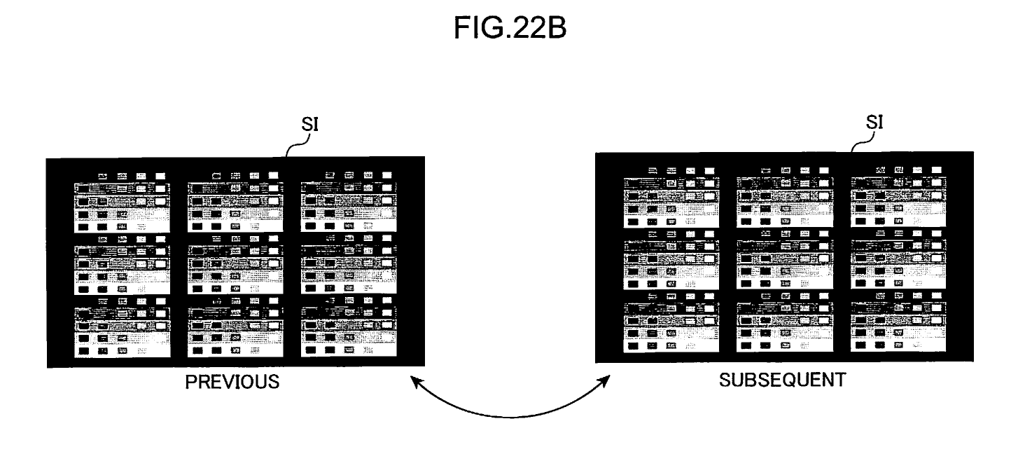

FIGS. 22A and 22B are schematic views of another exemplary combination of the pattern images, which are used upon evaluating the crosstalk by means of the foregoing two equations. The other combinations of the pattern images, which are used for the quantification of the crosstalk, are described with reference to FIGS. 15, 19A, 19B, 22A and 22B.

If the foregoing two equations are used, the combination of the pattern images shown in FIGS. 22A and 22B is also used in addition to the combination of the pattern images described with reference to FIGS. 19A and 19B. With regard to the combination shown in FIG. 22A, the first image FI is handled as the previously displayed image for calculating the quantitative value of the crosstalk. The second image SI is handled as the image, which is displayed after the first image FI. The combination in FIG. 22B means that the second image SI is repeatedly displayed.

In the display process described with reference to FIGS. 15 and 18, the image is displayed with two combination patterns (steps S210 and S220). If the combination of the image patterns shown in FIGS. 22A and 22B is used, four combination patterns are sequentially displayed in the display process. The brightness is measured for each combination of the displayed pattern images. Consequently, data about the parameters “Y_{x %, x %}”, “Y_{y %, y %}” used in the foregoing two equations are acquired.

### (Other Pattern Images)

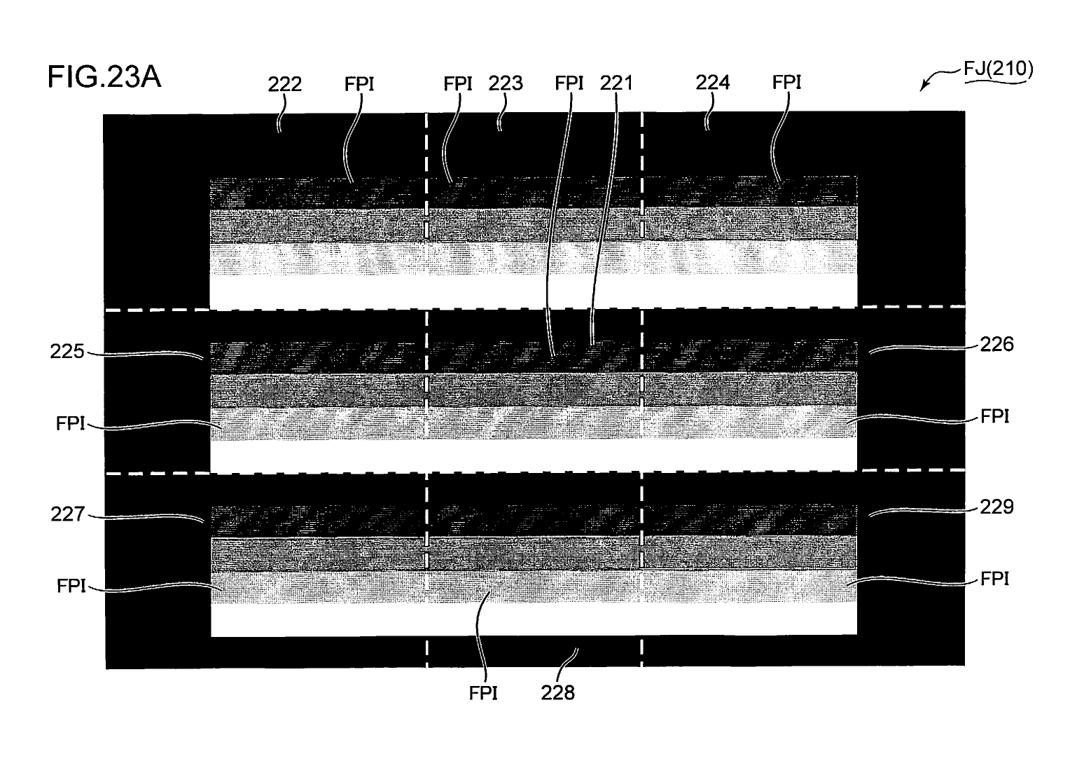

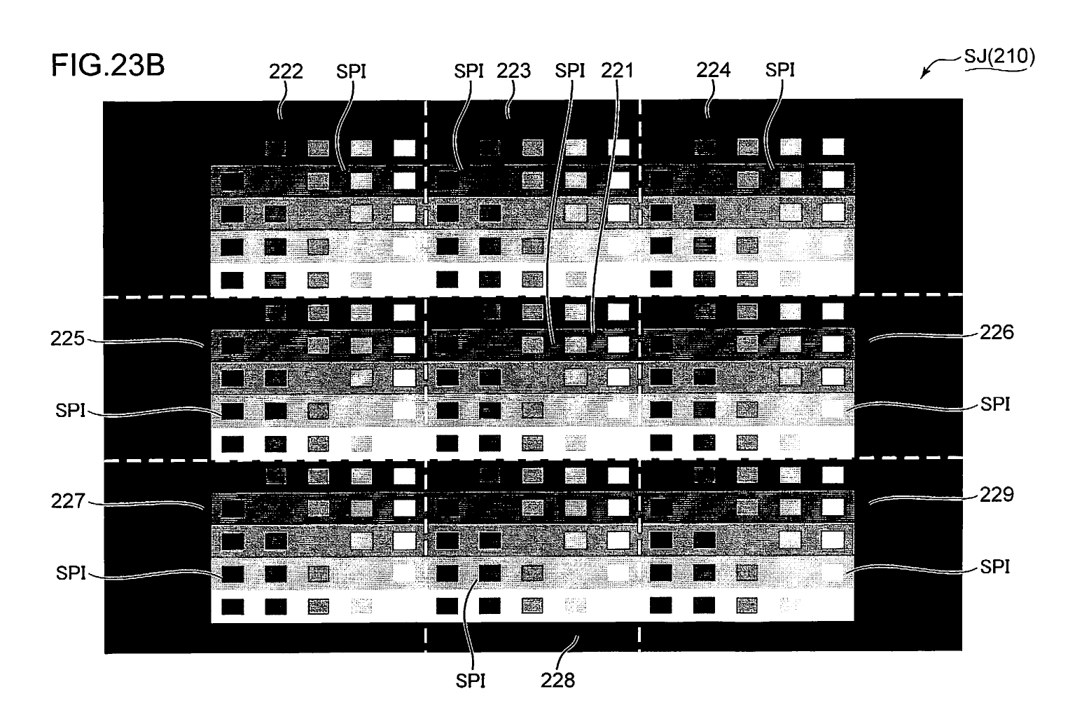

FIG. 23A is a schematic view of another exemplary first image FJ. FIG. 23B is a schematic view of another exemplary second image SJ. The other first image FJ is described by comparing FIG. 3 to FIG. 23A. The other second image SJ is described by comparing FIG. 4 to FIG. 23B.

As shown in FIG. 23A, the display surface 210 is conceptually compartmentalized into the display regions 221 to 229. In FIG. 23A, the conceptual compartment into the display regions 221 to 229 is defined so that the center display region 221 is occupied by the first pattern image FPI. The first pattern image FPI of the first image FJ depicted in the display regions 222, 225, 227 is shifted to the right in comparison with the position of the first pattern image FPI shown in FIG. 3. Consequently, the first pattern image FPI of the first image FJ depicted in the display regions 222, 225, 227 is viewed integrally with the first pattern image FPI depicted in the display regions 223, 221, 228.

The first pattern image FPI of the first image FJ depicted in the display regions 224, 226, 229 is shifted to the left in comparison with the position of the first pattern image FPI shown in FIG. 3. Consequently, the first pattern image FPI of the first image FJ depicted in the display regions 224, 226, 229 is viewed integrally with the first pattern image FPI depicted in the display regions 223, 221, 228.

The second image SJ includes several second pattern images SPI displayed at corresponding positions to each display position of the first pattern images FPI of the first image FJ. The first and second pattern images FPI, SPI shown in FIGS. 23A and 23B are clustered at the center of the display surface 210. Accordingly, crosstalk at the center region of the display surface 210, in which crosstalk is easily recognized, may be accurately detected.

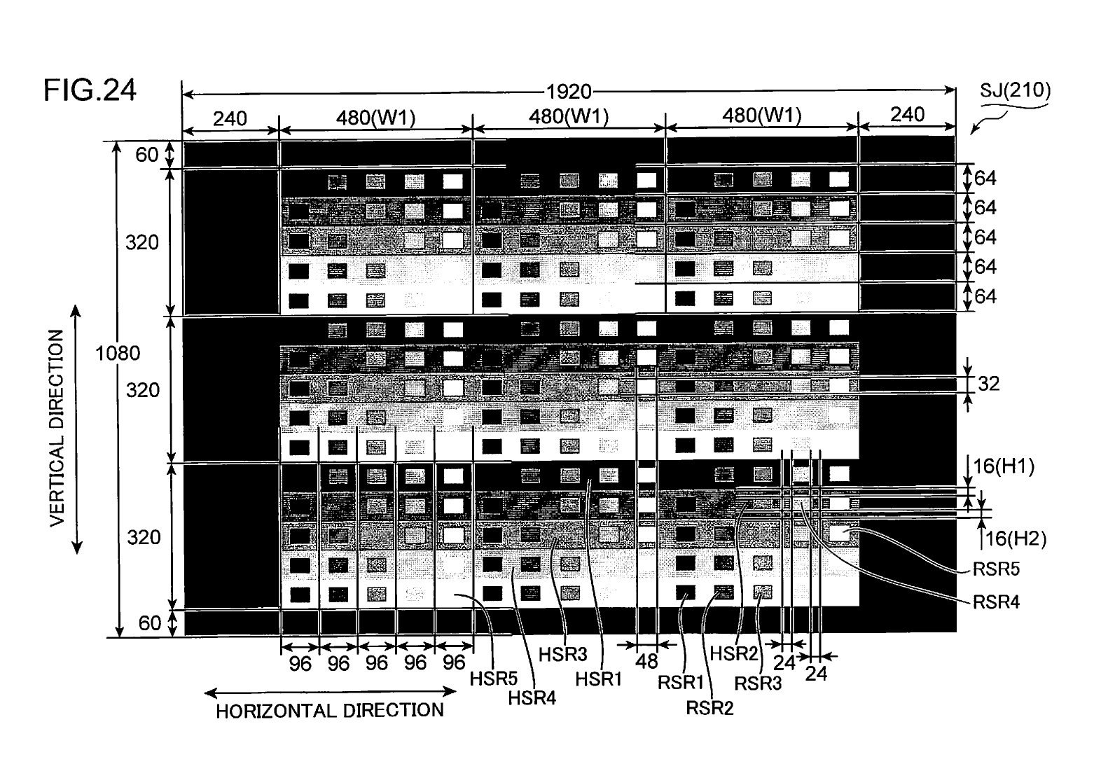

FIG. 24 shows dimensions of the second image SJ shown in FIG. 23B. The display surface 210 displaying the second image SJ shown in FIG. 24 has, as the whole, a reflectance, which is substantially 24% gray. In one implementation, the height dimension of each of the horizontal strip regions HSR1 to HSR5 is 64, and the height dimension of each of the rectangular regions RSR1 to RSR5 is 16. The rectangular regions RSR1 to RSR5 are disposed at the center of the horizontal strip regions HSR1 to HSR5 (in the vertical direction). Accordingly, the dimension “H1” between the upper edge of each of the rectangular regions RSR1 to RSR5 and the lower edge of each of the horizontal strip regions HSR1 to HSR5 is 16. Similarly, the dimension “H2” between the lower edge of each of the rectangular regions RSR1 to RSR5 and the lower edge of each of the horizontal strip regions HSR1 to HSR5 is 16. If the height dimension of the horizontal strip regions HSR1 to HSR5 is changed from 64 to 48, the value of the foregoing dimensions H1 and H2 becomes 8.

The display surface 210 displaying the second image SJ shown in FIG. 24 has, as the whole, a reflectance, which is substantially 18% gray. Consequently, crosstalk may be detected under a standard optical environment. In one implementation, each of the second pattern images SPI of the second image SJ has a width dimension value W1 (horizontal direction) of 480. If the width dimension W1 of the second pattern image SPI is changed from 480 to 360, like the change of the height dimension H1, the display surface 210 displaying the second image SJ shown in FIG. 24 has, as the whole, a reflectance, which is substantially 18% gray.

The dimensions of the patterns of the first and second images may be set so that average brightness of the display surface 210 becomes 15% or more and 25% or less in the display process described with reference to FIG. 21. Consequently, crosstalk may be detected under similar conditions to an environment in which a user views a video.

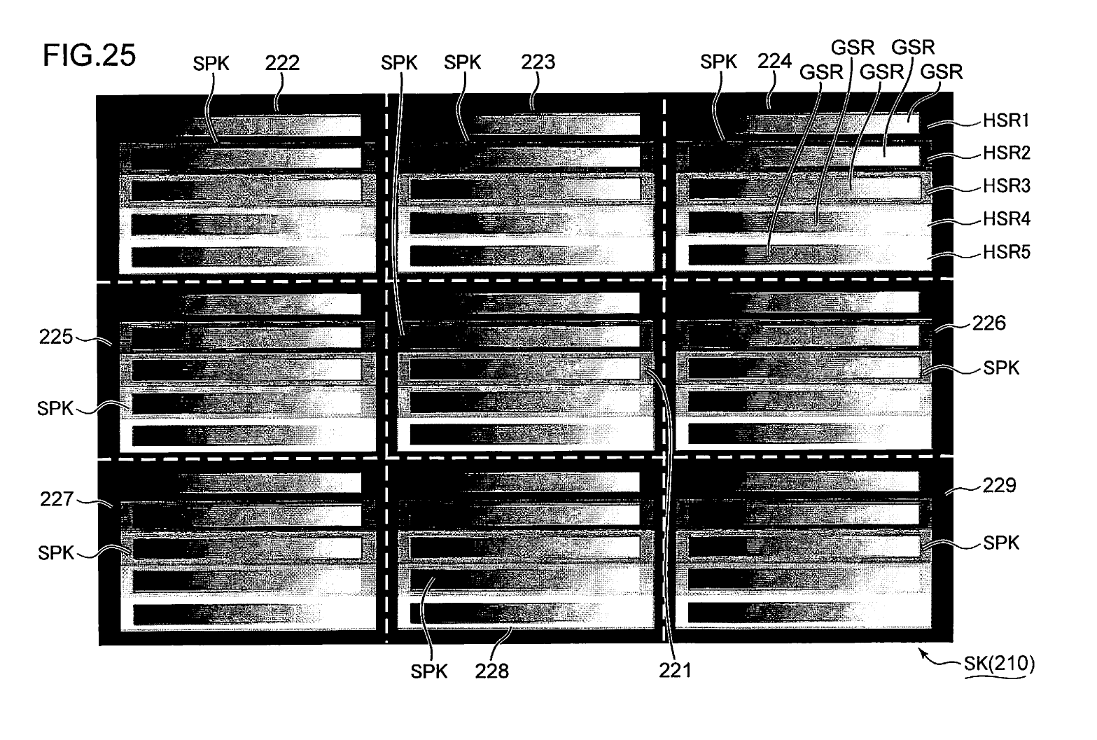

FIG. 25 is a schematic view of another exemplary second image SK. The second image SK may be used together with the first image FI instead of the foregoing second image SI. The second image SK includes nine second pattern images SPK displayed on each of the display regions 221 to 229. Similar to the second pattern image SPI, the second pattern image SPK includes the horizontal strip regions HSR1 to HSR5. The second pattern image SPK additionally includes a gradation strip region GSR displayed in each of the horizontal strip regions HSR1 to HSR5. The gradation strip region GSR horizontally extends like the horizontal strip regions HSR1 to HSR5. The brightness of the gradation strip region GSR gradually increases from the left end to the right end of the gradation strip region GSR. In this implementation, the gradation strip region GSR is exemplified as the sub region.

If the second image SK is used for the crosstalk detection, it may be possible to more easily visually confirm a region of the display surface 210 in which crosstalk occurs. Accordingly, the second image SK is suitably applied to intuitive crosstalk detection.

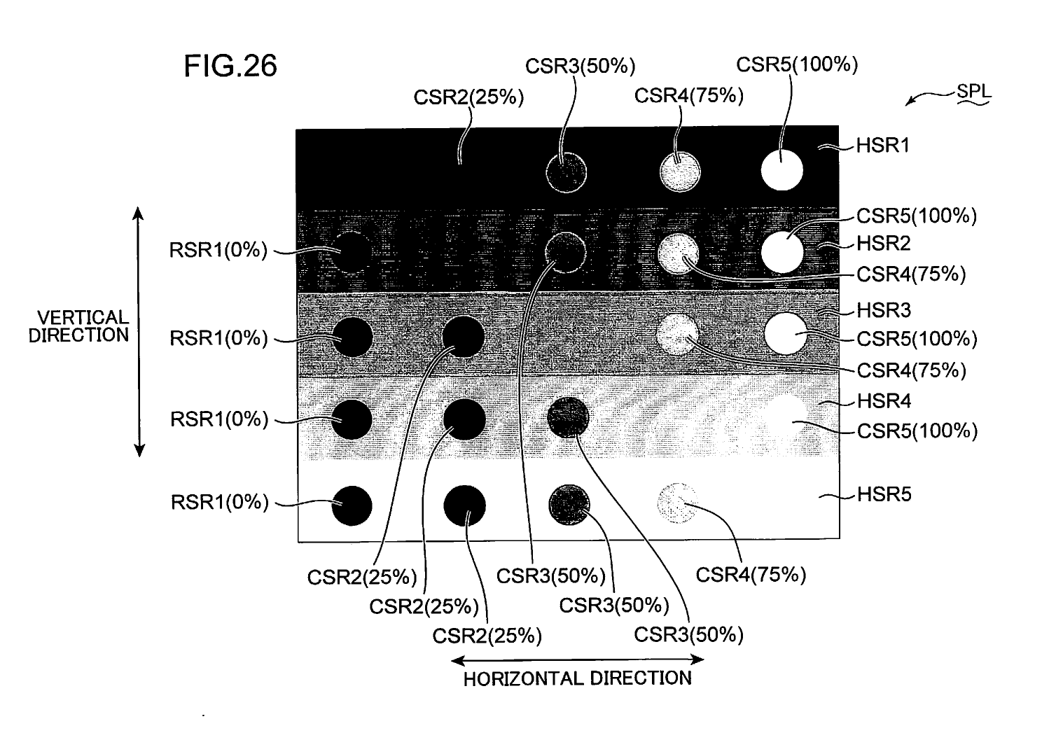

FIG. 26 is a schematic view of another exemplary second pattern image SPL. The second pattern image SPL is described by comparing FIG. 8 to FIG. 26. The second pattern image SPL includes the horizontal strip regions HSR1 to HSR5 like the second pattern image SPI described with reference to FIG. 8. However, unlike the second pattern image SPI described with reference to FIG. 8, the second pattern image SPL includes circular regions CSR1 to CSR5, which are smaller than the horizontal strip regions HSR1 to HSR5, instead of the rectangular regions RSR1 to RSR5.

The circular region CSR1 is displayed at a brightness level of “0%”. The circular region CSR2 is displayed at a brightness level of “25%”. The circular region CSR3 is displayed at a brightness level of “50%”. The circular region CSR4 is displayed at a brightness level of “75%”. The circular region CSR5 is displayed at a brightness level of “100%”. The four circular regions CSR2 to CSR5, which are depicted at different brightness levels from the horizontal strip region HSR1, are displayed in the horizontal strip region HSR1. The four circular regions CSR1, CSR3 to CSR5, which are depicted at different brightness levels from the horizontal strip region HSR2, are displayed in the horizontal strip region HSR2. The four circular regions CSR1, CSR2, CSR4, CSR5, which are depicted at different brightness levels from the horizontal strip region HSR3, are displayed in the horizontal strip region HSR3. The four circular regions CSR1 to CSR3, CSR5, which are depicted at different brightness levels from the horizontal strip region HSR4, are displayed in the horizontal strip region HSR4. The four circular regions CSR1 to CSR4, which are depicted at different brightness levels from the horizontal strip region HSR5, are displayed in the horizontal strip region HSR5.

In this implementation, each of the circular regions CSR1 to CSR5 is exemplified as the sub region. A group of the four circular regions CSR2 to CSR5 displayed in the horizontal strip region HSR1 may be exemplified as the first region group. Similarly, a group of the four circular regions CSR1, CSR3 to CSR5 displayed in the horizontal strip region HSR2 may be exemplified as the first region group. Similarly, a group of the four circular regions CSR1, CSR2, CSR4, CSR5 displayed in the horizontal strip region HSR3 may be exemplified as the first region group. Similarly, a group of the four circular regions CSR1 to CSR3, CSR5 displayed in the horizontal strip region HSR4 may be exemplified as the first region group. Similarly, a group of the four circular regions CSR1 to CSR4 displayed in the horizontal strip region HSR4 may be exemplified as the first region group.

The four circular regions CSR1 depicted at the brightness level of “0%” are vertically aligned. Similarly, the four circular regions CSR2 depicted at the brightness level of “25%” are vertically aligned. Similarly, the four circular regions CSR3 depicted at the brightness level of “50%” are vertically aligned. Similarly, the four circular regions CSR4 depicted at the brightness level of “75%” are vertically aligned. Similarly, the four circular regions CSR5 depicted at the brightness level of “100%” are vertically aligned. A group of the four circular regions CSR1 may be exemplified as the second region group. Similarly, a group of the four circular regions CSR2 may be exemplified as the second region group. Similarly, a group of the four circular regions CSR3 may be exemplified as the second region group. Similarly, a group of the four circular regions CSR4 may be exemplified as the second region group. Similarly, a group of the four circular regions CSR5 may be exemplified as the second region group. The group of the four circular regions CSR1, the group of the four circular regions CSR2, the group of the four circular regions CSR3, the group of the four circular regions CSR4, and the group of the four circular regions CSR5 are aligned substantially at regular intervals in the horizontal direction.

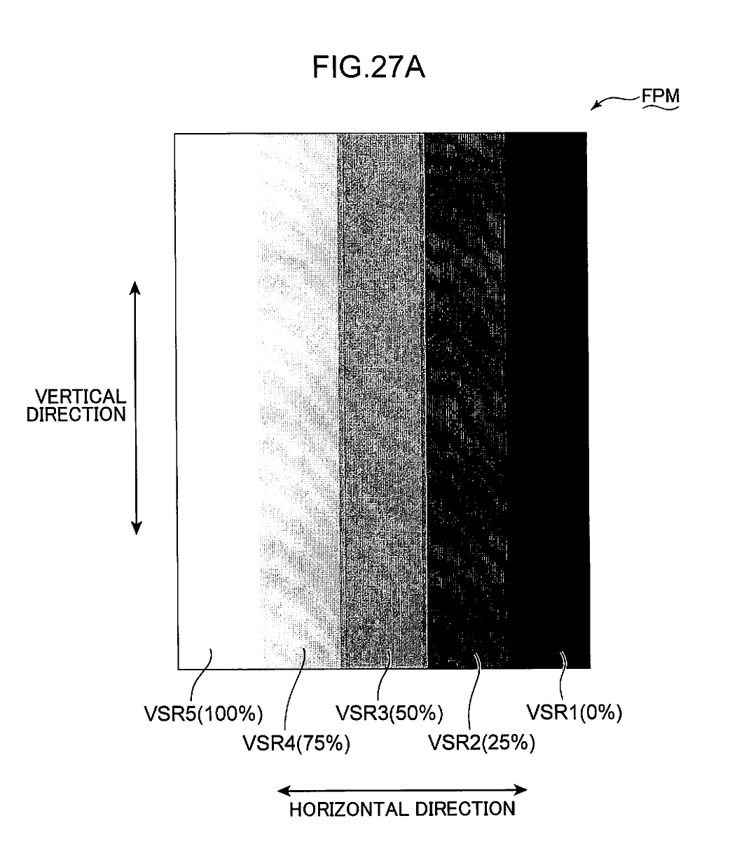

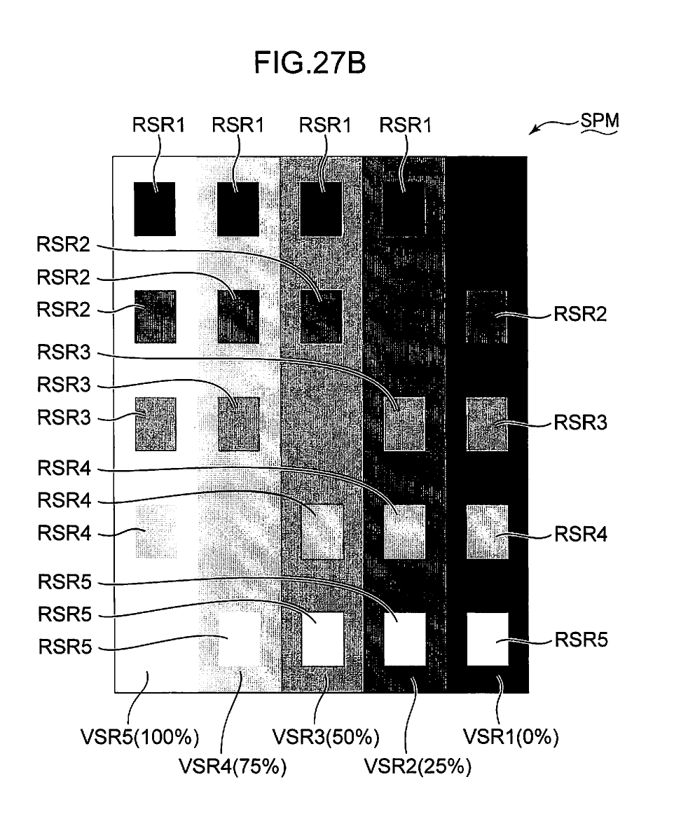

FIG. 27A is a schematic view of another exemplary first pattern image FPM. FIG. 27B is a schematic view of another exemplary second pattern image SPM. The first and second pattern images FPM, SPM are described by comparing FIG. 7 to FIG. 27A and comparing FIG. 8 to FIG. 27B. A first pattern image FPM includes five vertical strip regions VSR1 to VSR5. The vertical strip region VSR1 is the rightmost region in the first pattern image FPM. The vertical strip region VSR5 is the leftmost region in the first pattern image FPM. The vertical strip region VSR2 is the adjacent region to the vertical strip region VSR1. The vertical strip region VSR4 is the adjacent region to the vertical strip region VSR5. The vertical strip region VSR3 is the region between the vertical strip regions VSR2, VSR4.

In this implementation, the vertical strip regions VSR1 to VSR5 aligned in the vertical direction are identical in shape and size to each other. Alternatively, the vertical strip regions VSR1 to VSR5 may be different in length or width from each other. Each of the vertical strip regions VSR1 to VSR5 may be exemplified as the first main region. A brightness level of the vertical strip region VSR1 is “0%”. A brightness level of the vertical strip region VSR5 is “100%”. A brightness level of the vertical strip region VSR2 is “25%”. A brightness level of the vertical strip region VSR3 is “50%”. A brightness level of the vertical strip region VSR4 is “75%”. One of the vertical strip regions VSR1 to VSR5 is exemplified as the first main region. For example, if the vertical strip region VSR1 is exemplified as the first main region, the brightness level of “0%” is exemplified as the first brightness. One of the vertical strip regions VSR2 to VSR5, which are depicted with a higher brightness level than the vertical strip region VSR1, is exemplified as the second main region. For example, if the vertical strip region VSR2 is exemplified as the second main region, the brightness level of “25%” is exemplified as the second brightness. One of the vertical strip regions VSR3 to VSR5, which are depicted with a higher brightness level than the vertical strip region VSR2, is exemplified as the third main region. For example, if the vertical strip region VSR3 is exemplified as the third main region, the brightness level of “50%” is exemplified as the third brightness.

Similar to the first pattern image FPM, the second pattern image SPM includes the vertical strip regions VSR1 to VSR5. The second pattern image SPM additionally includes rectangular regions RSR1 to RSR5, which are smaller than the vertical strip regions VSR1 to VSR5. The four rectangular regions RSR2 to RSR5, which are depicted at different brightness levels from the vertical strip region VSR1, are displayed in the vertical strip region VSR1. The four rectangular regions RSR1, RSR3 to RSR5, which are depicted at different brightness levels from the vertical strip region VSR2, are displayed in the vertical strip region VSR2. The four rectangular regions RSR1, RSR2, RSR4, RSR5, which are depicted at different brightness levels from the vertical strip region VSR3, are displayed in the vertical strip region VSR3. The four rectangular regions RSR1 to RSR3, RSR5, which are depicted at different brightness levels from the vertical strip region VSR4, are displayed in the vertical strip region VSR4. The four rectangular regions RSR1 to RSR4, which are depicted at different brightness levels from the vertical strip region VSR5, are displayed in the vertical strip region VSR5.

A group of the four rectangular regions RSR2 to RSR5 displayed in the vertical strip region VSR1 may be exemplified as the first region group. Similarly, a group of the four rectangular regions RSR1, RSR3 to RSR5 displayed in the vertical strip region VSR2 may be exemplified as the first region group. Similarly, a group of the four rectangular regions RSR1, RSR2, RSR4, RSR5 displayed in the vertical strip region VSR3 may be exemplified as the first region group. Similarly, a group of the four rectangular regions RSR1 to RSR3, RSR5 displayed in the vertical strip region VSR4 may be exemplified as the first region group. Similarly, a group of the four rectangular regions RSR1 to RSR4 displayed in the vertical strip region VSR5 may be exemplified as the first region group.

In this implementation, each of the vertical strip regions VSR1 to VSR5 exemplified as the main region extends in the vertical direction. Accordingly, the vertical direction is exemplified as the first direction.

The four rectangular regions RSR1 depicted at the brightness level of “0%” are aligned in the horizontal direction. Similarly, the four rectangular regions RSR2 depicted at the brightness level of “25%” are aligned in the horizontal direction. Similarly, the four rectangular regions RSR3 depicted at the brightness level of “50%” are aligned in the horizontal direction. Similarly, the four rectangular regions RSR4 depicted at the brightness level of “75%” are aligned in the horizontal direction. Similarly, the four rectangular regions RSR5 depicted at the brightness level of “100%” are aligned in the horizontal direction. In this implementation, the horizontal direction is exemplified as the second direction. A group of the four rectangular regions RSR1 may be exemplified as the second region group. Similarly, a group of the four rectangular regions RSR2 may be exemplified as the second region group. Similarly, a group of the four rectangular regions RSR3 may be exemplified as the second region group. Similarly, a group of the four rectangular regions RSR4 may be exemplified as the second region group. Similarly, a group of the four rectangular regions RSR5 may be exemplified as the second region group. The group of the four rectangular regions RSR1, the group of the four rectangular regions RSR2, the group of the four rectangular regions RSR3, the group of the four rectangular regions RSR4, and the group of the four rectangular regions RSR5 are aligned substantially at regular intervals in the vertical direction.

With respect to the various pattern images described above, the average brightness of the first pattern image may substantially coincide with the average brightness of the second pattern image. For example, with reference to FIGS. 7 and 8, if the four rectangular regions RSR1 are replaced with the four rectangular regions RSR2 to RSR5 displayed in the horizontal strip region HSR1, the result substantially coincides with the horizontal strip region HSR1 of the first pattern image FPI. Likewise, if the position of the rectangular regions RSR1 to RSR5 in the second pattern image SPI is changed, an identical image pattern is created to the first pattern image FPI. Consequently, detection errors of the crosstalk caused by variation in the average brightness may be reduced.

### (Signal Generation Program)

As described with reference to FIG. 5, the signal generating device 300 outputs the first and second signals in order to display the first and second images. The first and second signals may be generated, for example, by means of a program, which is executed by a CPU used as the signal generation portion 320. It should be noted that the program may be stored in the storage portion 310 for storing the data about the first and second images, or stored in another storage medium.

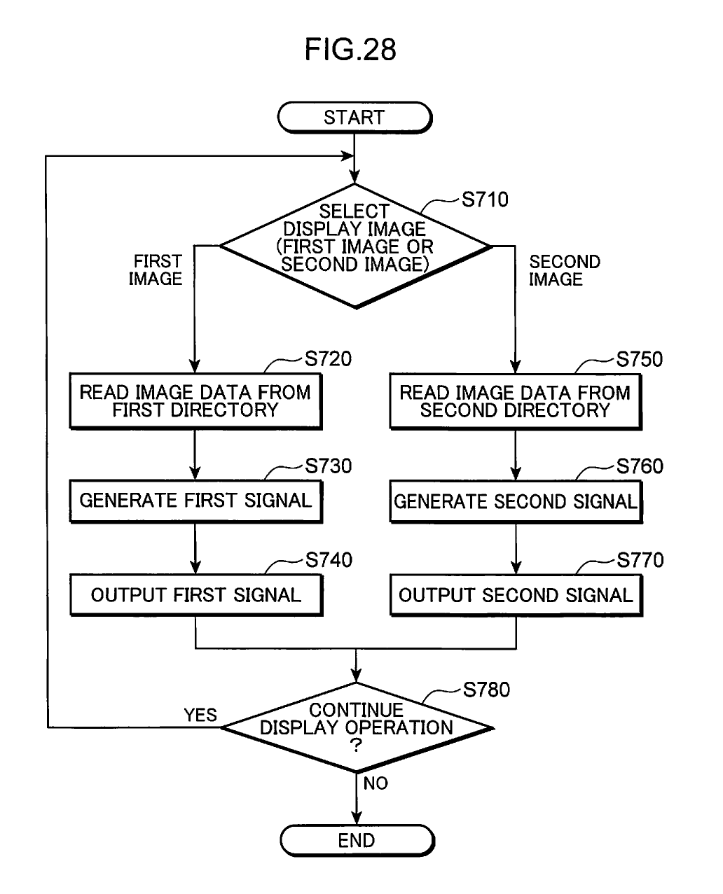

FIG. 28 is a flowchart schematically showing an exemplary process, which is executed by the signal generation program for causing the signal generating device 300 to generate the first and second signals. The signal generation program is described with reference to FIGS. 5, 15 and 28. Upon completing the setup process described with reference to FIG. 15, the signal generation program executes step S710. In step S710, the signal generation program selects one of the first and second images as an image to be displayed. It should be noted that, in the initial processing routine, the signal program may select one of the first and second images as a default image. If the first image is selected in the immediately preceding processing routine, the second image is selected in the subsequent processing routine. If the second image is selected in the immediately preceding processing routine, the first image is selected in the subsequent processing routine. In step S710, if the first image is selected, step S720 is executed. In step S720, if the second image is selected, step S750 is executed.

In step S720, the signal generation program causes the signal generation portion 320 to read the data about the first image from the first directory 311. Subsequently, step S730 is executed. In step S730, the signal generation program causes the signal generation portion 320 to generate the first signal on the basis of the data about the first image. The signal generation program thereafter causes the signal generation portion 320 to output the first signal to the output portion 330. When the first signal is input to the output portion 330, step S740 is executed.

In step S740, the signal generation program causes the output portion 330 to output the first signal to the display device 200. Consequently, the display device 200 outputs the first image. When the first signal is output to the display device 200, step S780 is executed. In step S750, the signal generation program causes the signal generation portion 320 to read the data about the second image from the second directory 312. Subsequently, step S760 is executed. In step S760, the signal generation program causes the signal generation portion 320 to generate the second signal on the basis of the data about the second image. The signal generation program thereafter causes the signal generation portion 320 to output the second signal to the output portion 330. When the second signal is input to the output portion 330, step S770 is executed.

In step S770, the signal generation program causes the output portion 330 to output the second signal to the display device 200. Consequently, the display device 200 outputs the second image. When the second signal is output to the display device 200, step S780 is executed. In step S780, the signal generation program determines whether the display operation of the first or second image is continued. The determination of whether to continue the display operation may rely, for example, on a measurement time, which is set in the setup process or other criteria. Once it is determined that the display operation is not continued, the signal generation program ends the process. If it is determined that the display operation is continued, step S710 is executed once again.

In the foregoing implementation, the crosstalk is evaluated under an active display environment. However, the principle of the foregoing implementation may be applied to a passive display environment. For example, the display device may display pattern images upon changing the polarization properties. Instead of the shutter device 450, a polarization filter or other optical elements capable of selecting transmission or blocking of light according to the polarization properties of the video light may be used. Crosstalk may be appropriately detected and evaluated even under the foregoing optical environment.

In the foregoing implementation, the crosstalk is evaluated by means of a gray scale. However, the principle of the foregoing implementation may be applied, for example, to emission of one hue among the three primary colors (RGB).

(Advantages of this Implementation)

The principle of this implementation is characterized in that the pattern images (first or second pattern images) are simultaneously displayed over the display surface 210. If a single pattern image is displayed over the display surface, it may be difficult to determine whether the crosstalk observed on the display surface is caused by the brightness characteristics of the display surface or by the pattern images. If a single pattern image is used for identifying the crosstalk which is caused by the brightness characteristics of the display surface, it may be necessary to display a single pattern image on a part of the display surface to identify the crosstalk. Subsequently, it may be necessary to change the display position of the single pattern image and separately evaluate the crosstalk. Consequently, if a single pattern image is used for identifying the crosstalk which is caused by the brightness characteristics of the display surface, it may be necessary to repeat the measurement of the crosstalk.

The repetitive measurement of the crosstalk may cause errors between the measurements. For example, a temperature of the display surface may change between one measurement and another measurement. Since the temperature of the display surface is closely relevant to the crosstalk generation, with an increased number of times that crosstalk is measured, the error between the measurement data can increase.

In this implementation, the pattern images (first or second pattern images) can be simultaneously displayed over the display surface 210. Accordingly, it may become less likely that the crosstalk has to be repeatedly measured. Thus, the crosstalk data acquired on the basis of the principle of this implementation may contain few errors caused by a temporal temperature change of the display surface 210.

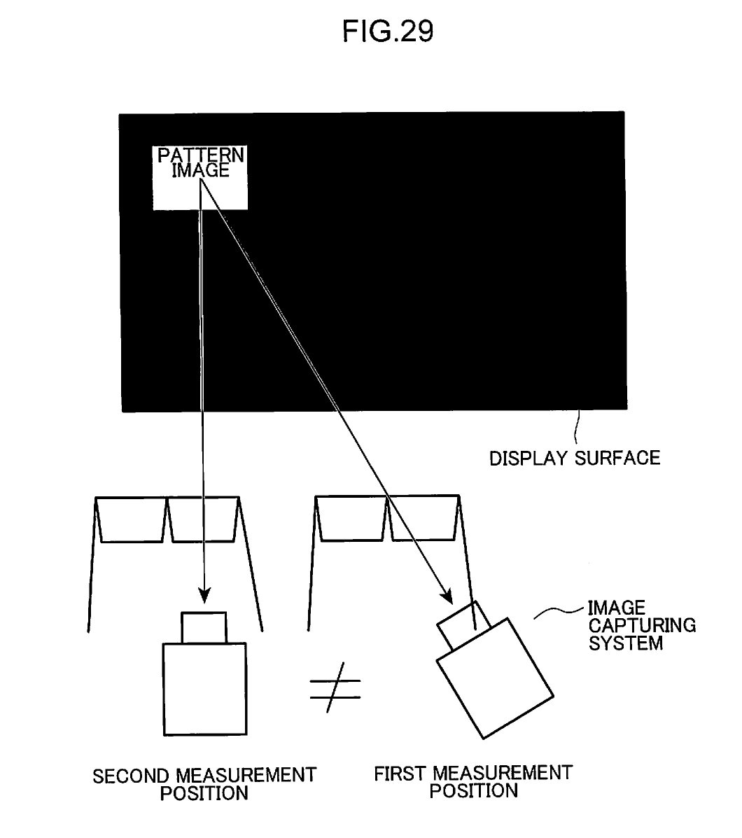

FIG. 29 is a schematic view of the measurement of the crosstalk under a display environment in which a single pattern image is displayed. The advantages of this implementation are further described by comparison with the measurement method shown in FIG. 29. FIG. 29 shows measurement by an image capturing system disposed at a first measurement position facing the center of the display surface, and the measurement by an image capturing system disposed at a second measurement position, which is left to the first measurement position. A pattern image is displayed at the upper left corner of the display surface shown in FIG. 29.

An imaging angle of the pattern image is different between the first and second measurement positions. The difference in the imaging angle causes deviation between the crosstalk data measured at the first and second measurement positions. In many cases, since a viewer viewing the video faces the center of the display surface, the crosstalk data measured at the second measurement position may deviate from actual perception of a viewer about the crosstalk.

As shown in FIG. 1, in this implementation, the image capturing system 400 is positioned so that the image capturing system 400 faces the display surface 210. In addition, the image capturing system 400 takes an image of the overall display surface 210. Accordingly, the image capturing system 400 may measure the crosstalk under an optical setting, which is close to an actual viewing environment of a viewer.

The various implementations described above are merely exemplary. Accordingly, the principle of the foregoing implementations is not limited to the foregoing detailed description or matters described in the drawings. It may be easily understood that a person skilled in the art may perform various modifications, combinations or omissions within a scope of the principle of the foregoing implementations.

The aforementioned implementations mainly include the following features. The method for detecting crosstalk on a display surface which is compartmentalized into display regions by identical image patterns that are contained in an input image signal to a display device according to one aspect of the aforementioned implementation includes: displaying a first image and a second image on a display surface, the first image including first pattern images having main regions depicted with different brightness from each other and the second image including second pattern images having the main regions and sub regions depicted with different brightness from the main regions; taking an image of the display surface to obtain image data; and comparing at least one of the first and second images with the image data to detect the crosstalk. The first and second pattern images are displayed in a center region at a center of the display surface and adjacent regions adjacent to the center region.

An image of the display surface is taken to obtain the image data when the display surface displays the first image, which includes the first pattern images, and the second image, includes the second pattern images. At least one of the first and second images is compared with the image data. Consequently, the crosstalk appearing on the display surface is appropriately detected. Since the crosstalk is detected on the basis of the image data about the first and second pattern images displayed on the display surface, the crosstalk data become less susceptible to a temporal temperature change. Therefore, the crosstalk data may be more easily reproduced.

The first pattern images are displayed on the center region and the adjacent regions. The second pattern images are also displayed on the center region and the adjacent regions. Consequently, the crosstalk in the center region and the adjacent regions may be substantially simultaneously detected. Accordingly, the crosstalk data may become less susceptible to a temporal temperature change among the display regions. Therefore, the crosstalk data may be more easily reproduced.

As described above, since the crosstalk in the center region and the adjacent region can be simultaneously detected, the crosstalk can be detected under similar conditions to an actual viewing environment of a viewer. Accordingly, data about the detected crosstalk may become more reliable.

The display surface may be compartmentalized into the nine display regions. To this end, the first pattern image is displayed in each of the nine display regions. The second pattern image is also displayed in each of the nine display regions. Consequently, crosstalk on the entire display surface may be substantially simultaneously detected. Accordingly, the crosstalk data may become less susceptible to a temporal temperature change. Therefore, the crosstalk data may become more easily reproducible. Furthermore, since the crosstalk in the nine display regions may be substantially simultaneously detected, the crosstalk may be detected under similar conditions to an actual viewing environment of a viewer. Accordingly, data about the detected crosstalk may become reliable.

In the aforementioned configuration, the main regions may include a first main region depicted with first brightness, a second main region depicted with second brightness, which is higher than the first brightness, and a third main region depicted with third brightness, which is higher than the second brightness. Accordingly, crosstalk in a region depicted with an intermediate gradation may be appropriately detected.

According to the aforementioned configuration, the main regions may include the first main region depicted with first brightness. The sub regions may include a first region group, which consists of sub regions which are depicted with different brightness from each other within the first main region. Since the brightness of the sub regions of the first region group is mutually different, crosstalk of a region depicted with an intermediate gradation may be appropriately detected. The sub region may be a rectangular or circular sub region. Since the sub region may be rectangular or circular, the crosstalk may be quantitatively evaluated with simple calculations.

In the aforementioned configuration, the main regions may include a first main region depicted with first brightness. The first main region may be a horizontal strip region, which extends in a horizontal direction or a vertical strip region, which extends in a vertical direction. The sub regions in the first main region may form a gradation pattern in which the brightness increases or decreases in the horizontal direction in the horizontal strip region, or form a gradation pattern in which the brightness increases or decreases in the vertical direction in the vertical strip region. Accordingly, it may become easy to qualitatively identify regions where the crosstalk occurs.

In the aforementioned configuration, the first main region may be a strip region extending in a first direction, the sub regions may include second region groups, which include regions aligned in a second direction orthogonal to the first direction, and the second region groups may be aligned at regular intervals in the first direction. Since the second region groups may be aligned at regular intervals in the first direction, the crosstalk may be quantitatively evaluated with simple calculations.

An average brightness of the first pattern image may be equal to an average brightness of the second pattern image. As a result, a difference in brightness between the first and second pattern images may not affect the detected crosstalk.

In the step of displaying the first and second images on the display surface, an average brightness of the display surface may be maintained within a range of 15% or more and 25% or less. As a result, the crosstalk may be detected under similar conditions to an actual viewing environment of a viewer.

In another aspect, the instant application describes a signal generating device configured to generate image signals for displaying images used for detecting crosstalk on a display surface of a display device. The signal generating device includes a signal generation portion configured to generate a first signal for displaying a first image and a second signal for displaying a second image, the first image includes first pattern images having main regions depicted with different brightness from each other and the second image includes second pattern images having the main regions and sub regions depicted with different brightness from the main regions. The signal generating device also includes an output portion configured to output the first and second signals. The signal generation portion is configured to generate the second signal so that the second pattern images are displayed in a center region at a center of the display surface and adjacent regions adjacent to the center region and to generate the first signal so that the first pattern images are displayed in the center region and each of the adjacent regions. According to this implementation, less susceptible crosstalk to a temporal temperature change appears on the display surface. Since the crosstalk on the display surface may be substantially simultaneously detected, the crosstalk may be simulated under similar conditions to an actual viewing environment of a viewer.

The first pattern images may include the main regions which are depicted with different brightness. The first signal may depict the main regions with different brightness from each other. The second pattern images may include the main regions and the sub regions which are depicted in the main regions. The second signal may depict the sub regions with different brightness from the main regions, which surround the sub regions. Accordingly, appropriate crosstalk may appear on the display surface.

In another aspect, the instant application describes a computer-readable non-transitory medium storing an image file to be used for detecting crosstalk on a display surface compartmentalized into display regions by image patterns that are contained in an input image signal to a display device. The computer-readable non-transitory medium is configured to store data about a first image and a second image. The first image includes first pattern images having main regions depicted with different brightness from each other. The second image includes second pattern images having the main regions and sub regions depicted with different brightness from the main regions. The computer-readable non-transitory medium is further configured to display the first and second pattern images on the display regions. According to this implementation, less susceptible crosstalk to a temporal temperature change may be created by means of the image file. Since the crosstalk may be displayed on the substantially entire display surface, the crosstalk may be simulated under similar conditions to an actual viewing environment of a viewer.

The first pattern images may include the main regions, which are depicted with different brightness. The first signal may depict the main regions with different brightness from each other. The second pattern images may include the main regions and the sub regions which are depicted in the main regions. Since the second pattern images may be displayed on the display regions in which the first pattern images are displayed, crosstalk appropriately appears on the display surface.

The program according to yet another aspect of the aforementioned implementation causes a computer to execute a step of reading data about a first image including first pattern images, which include main regions that are depicted with different brightness from each other, and data about a second image, which includes second pattern images that have the main regions and sub regions depicted with different brightness in the main regions. The program further causes the computer to execute a step of generating a first signal and a second signal on the basis of data about the first and second images, respectively so that the second pattern images are displayed on display regions, which are compartmentalized as regions where the first pattern images are displayed. The program further causes the computer to execute a step of outputting the first and second signals.

According to the aforementioned configuration, the program causes a computer to read data about the first and second pattern images. Accordingly, less susceptible crosstalk to a temporal temperature change may be created by means of the image file. Furthermore, since the crosstalk may be displayed on the substantially entire display surface, the crosstalk may be simulated under similar conditions to an actual viewing environment of a viewer.

In another general aspect, the instant application describes a display device that includes a display surface configured to display a first image including first pattern images that have main regions depicted with different brightness from each other. The display surface is being compartmentalized into display regions, each display region being used to display one of the first pattern images. The display device further includes an input portion configured to receive a first signal for displaying the first image and a second signal for displaying a second image including second pattern images that have the main regions and sub regions depicted with different brightness from the main regions on the display surface; and an adjuster configured to adjust brightness characteristics of the display surface. The display surface is configured to display each of the second pattern images in one of the display regions if the second signal is input to the input portion.

The display surface displays the first pattern images, which include the main regions depicted with different brightness in response to the first signal received by the input portion. The display surface displays the second pattern images in the display regions in response to the second signal received by the input portion. Consequently, less susceptible crosstalk to a temporal temperature change may appear on the display surface. Furthermore, since the crosstalk corresponding to the first and/or second pattern images may be substantially simultaneously displayed, the crosstalk may be simulated under similar conditions to an actual viewing environment of a viewer.

As a result of simulating crosstalk, the brightness characteristics of regions where distinct crosstalk appears on the display surface may be adjusted by the adjuster. Accordingly, the display device may display images with little crosstalk.

In another aspect, the instant application describes a method for manufacturing a display device including a display surface which is compartmentalized into display regions by image patterns contained in an image signal. The method includes steps of: displaying a first image and a second image on a display surface, the first image including first pattern images having main regions depicted with different brightness from each other and the second image including second pattern images having the main regions and sub regions depicted with different brightness from the main regions; taking an image of the display surface to obtain image data when the display surface displays the first and second images; and comparing at least one of the first and second images with the image data to inspect crosstalk characteristics. Accordingly, the crosstalk may be appropriately detected as a result of comparison between at least one of the first and second images and the image data.

The first pattern images of the first image are displayed on the display regions. Similarly, the second pattern images are displayed on the display regions. Thus, crosstalk corresponding to the first and/or second pattern images may be substantially simultaneously detected. Accordingly, the crosstalk data may become less susceptible to a temporal temperature change among the display regions. Therefore, the crosstalk data may become more easily reproducible.

The principle of the aforementioned implementations may be suitably applied to a display device configured to display images, or to inspection and manufacture of such a display device.

Other implementations are contemplated.

What is claimed is:

1. A method for detecting crosstalk on a display surface compartmentalized into display regions by image patterns that are contained in an input image signal to a display device, the method comprising:
displaying a first image and a second image on a display surface, the first image including first pattern images having main regions depicted with different brightness from each other and the second image including second pattern images having the main regions and sub regions depicted with different brightness from the main regions;
taking an image of the display surface to obtain image data; and
comparing at least one of the first and second images with the image data to detect the crosstalk, wherein
the first and second pattern images are displayed in a center region at a center of the display surface and adjacent regions adjacent to the center region.

2. The method according to claim 1, further comprising:
compartmentalizing the display surface into the center region and the adjacent regions surrounding the center region;
displaying the first pattern images in the center region and each of the adjacent regions; and
displaying the second pattern images in the center region and each of the adjacent regions.

3. The method according to claim 2, wherein the display surface is compartmentalized into nine display regions.

4. The method according to claim 1, wherein the main regions include a first main region depicted with first brightness, a second main region depicted with second brightness, which is higher than the first brightness, and a third main region depicted with third brightness, which is higher than the second brightness.

5. The method according to claim 1, wherein
the main regions include a first main region depicted with first brightness, and
the sub regions include a first region group including sub regions, which are depicted with different brightness from each other, within the first main region.

6. The method according to claim 1, wherein the sub regions are rectangular or circular.

7. The method according to claim 1, wherein
the main regions include a first main region depicted with first brightness,
the first main region is a horizontal strip region extending in a horizontal direction or a vertical strip region extending in a vertical direction, and
the sub regions are formed in the first main region, the sub regions form a gradation pattern in which the brightness increases or decreases in the horizontal direction in the horizontal strip region, or form a gradation pattern in which the brightness increases or decreases in the vertical direction in the vertical strip region.

8. The method according to claim 5, wherein
the first main region is a strip region extending in a first direction,
the sub regions include second region groups, which include sub regions aligned in a second direction orthogonal to the first direction, and
the second region groups are aligned at regular intervals in the first direction.

9. The method according to claim 1, wherein an average brightness of each of the first pattern images is equal to an average brightness of each of the second pattern images.

10. The method according to claim 1, wherein in the step of displaying the first and second images on the display surface, an average brightness of the display surface is maintained within a range of 15% or more and 25% or less.

11. A signal generating device configured to generate image signals for displaying images used for detecting crosstalk on a display surface of a display device, the signal generating device comprising:
a signal generation portion configured to generate a first signal for displaying a first image and a second signal for displaying a second image, the first image includes first pattern images having main regions depicted with different brightness from each other and the second image includes second pattern images having the main regions and sub regions depicted with different brightness from the main regions; and
an output portion configured to output the first and second signals, wherein
the signal generation portion is configured to generate the second signal so that the second pattern images are displayed in a center region at a center of the display surface and adjacent regions adjacent to the center region and to generate the first signal so that the first pattern images are displayed in the center region and each of the adjacent regions.

12. A computer-readable non-transitory medium storing an image file to be used for detecting crosstalk on a display surface compartmentalized into display regions by image patterns that are contained in an input image signal to a display device, the computer-readable non-transitory medium is configured to:
store data about a first image and a second image, the first image including first pattern images having main regions depicted with different brightness from each other and the second image including second pattern images having the main regions and sub regions depicted with different brightness from the main regions; and
display the first and second pattern images on the display regions.

13. A display device comprising:
a display surface configured to display a first image including first pattern images that have main regions depicted with different brightness from each other, the display surface being compartmentalized into display regions, each display region being used to display one of the first pattern images;
an input portion configured to receive a first signal for displaying the first image and a second signal for displaying a second image including second pattern images that have the main regions and sub regions depicted with different brightness from the main regions on the display surface; and
an adjuster configured to adjust brightness characteristics of the display surface, wherein
the display surface is configured to display each of the second pattern images in one of the display regions if the second signal is input to the input portion.

14. A method for manufacturing a display device including a display surface which is compartmentalized into display regions by image patterns contained in an image signal, the method comprising:
displaying a first image and a second image on a display surface, the first image including first pattern images having main regions depicted with different brightness from each other and the second image including second pattern images having the main regions and sub regions depicted with different brightness from the main regions;
taking an image of the display surface to obtain image data; and
comparing at least one of the first and second images with the image data to inspect crosstalk characteristics.
